(19) United States
(12) Patent Application Publication
(10) Pub. No.: US 2009/0314835 A1
(43) Pub. Date: Dec. 24, 2009

(54) SYSTEM FOR SHIPPING AN ITEM USING AN ELECTRONIC ENVELOPE

(75) Inventor: Corey Jackson, Alpharetta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Services of America, Inc.

(21) Appl. No.: 12/144,231

(22) Filed: Jun. 23, 2008

(51) Int. Cl. G07B 15/02

(52) U.S. Cl. 235/384

(57) ABSTRACT

The disclosed system enables a sender to ship an item in an envelope using a mobile shipping application running on a computing device or carrier computer. This system includes an electronic envelope having an updateable flexible electronic visual display that displays shipping information transmitted by a carrier computer via a wireless network, a cellular chip for receiving updated shipping information from the carrier computer, and a microcomputer chip for transmitting the information to the electronic display. The computing device, carrier computer, or both, execute the mobile shipping application that is accessible with a computing device and through which a sender places a shipping order. The system further comprises a carrier computer configured to execute the mobile shipping application running on the carrier computer, a data storage device to store the shipping orders, and a transceiver for communicating with the cellular chip on the envelope across a wireless communications network.

### BACKGROUND OF THE DISCLOSURE

The present disclosure generally relates to a unique methods and systems for shipping an item using an envelope. More particularly, this disclosure relates to a system by which a sender may conveniently ship an envelope from any location by placing a shipping order through a mobile shipping application accessible by a computing device and by which the carrier may update the information on the envelope throughout the shipping process.

Shipping an envelope has traditionally required that a sender place the item in the envelope, write the destination address on the envelope, and place the envelope in the mail box. As technology has evolved, a sender has obtained the ability to print a label from a computer and attach the label to the envelope to indicate the destination address. And even more recently, carriers have computerized their entire shipping systems to allow tracking of shipments based on the tracking number assigned to the shipment.

However, drawbacks still remain even with the most recent improvements. A primary drawback is that the sender must have some means for labeling an envelope. This may include methods such as handwriting the destination address, using a printer to print the destination address directly on the envelope, or using a printer to print a label to be attached to the envelope. Moreover, if a sender wishes to send an envelope that will be afforded a tracking number, a sender generally must either (1) send the envelope from a carrier location, (2) send the envelope using a pre-printed, fill-in-the-blank label that includes a pre-assigned tracking number, or (3) send the envelope from a computer that is attached to a printer so that the sender may print the label and attach it to an envelope. These scenarios pose significant limitations on sender ability to conveniently ship an envelope in certain contexts. For example, when a sender is traveling, the sender may not have convenient access to a computer or writing utensil to send an envelope using the above techniques.

Additionally, envelopes are typically not reusable. This may be due to a number of factors, including the fact that an envelope may be damaged or worn during shipping or destroyed upon opening. Other factors that preclude reusability include the fact that the destination address may be printed or written directly on the envelope and cannot be clearly reprinted or because the label on the envelope simply cannot be reused. Thus, given the present low cost for disposable envelopes, under the present market and design trends, disposable envelopes remain the norm.

Although one may suppose that reusability could be achieved through the use of larger envelopes comprised of stiffer materials, in fact, such envelopes would be greatly damaged during shipment. Sorting and transport machinery require that an envelope possess a certain amount of flexibility in order to avoid damage or destruction during shipping.

Further, a sender loses security or privacy by having to write or print the destination address on the outside of an envelope. Anyone who views or handles the envelope may learn the destination of the envelope, from the time the sender turns over the envelope to a carrier until the time when the envelope arrives at its destination.

Finally, the sending of letters or documents generally requires that the sender specify the destination address at the time of shipment. It would be desirable to provide a sender with the flexibility to define a destination address or handling instructions after delivering a letter to a carrier.

Accordingly, it would be desirable to provide a system for shipping an envelope that provides one or more of the following advantages: (1) convenience to the sender in shipping an envelope using a mobile device; (2) security or privacy as to the intended destination address; (3) reusability of an envelope of flexible and durable design; and (4) the capability to alter the label on an envelope in transit to the destination address.

### BRIEF SUMMARY OF THE DISCLOSURE

The present disclosure provides for methods and systems for shipping an item using an electronic envelope. According to various embodiments of the present disclosure, a method for shipping an item using an electronic envelope includes a carrier computer remotely prompting a sender of the electronic envelope to enter a unique identifier of the electronic envelope, in which the electronic envelope has a long-range communications chip and an electronic display. Further, the carrier computer will receive the unique identifier of said electronic envelope and prompts the sender to enter shipping information, including a shipping address, to be associated with the unique identifier of the envelope. The carrier computer will also receive the shipping information and store the shipping information in association with the unique identifier. Additionally, the carrier computer will transmit the shipping information from to the long-range communications chip on the electronic envelope.

In some embodiments, the carrier will distribute the electronic envelope to the sender prior to the sender placing a order to ship and item using the electronic envelope, and in other embodiments, the sender may reuse an electronic envelope that the sender received from another person or entity who was shipping an item to the sender in the electronic envelope.

The carrier computer may transmit shipping information to the long-range communications chip on the electronic envelope in periodic intervals, beginning with the placement of a shipping order. In other embodiments, the carrier computer may transmit shipping information to the long-range communications chip on the electronic envelope if the sender updates said shipping information after placing a shipping order or if the receiver updates said shipping information after a sender has placed a shipping order.

Furthermore, the long-range communications chip may have the capability to determine the location of the electronic envelope so that the electronic display may display information based on the location of the electronic envelope. In various embodiments, the long-range communications chip may utilize a global positioning system (GPS) chip included in the long-range communications chip to determine the location of the envelope so that the electronic display may display information based on the location of the envelope. In other embodiments, the long-range communications chip may utilize a global positioning system (GPS) chip included on the electronic envelope to determine the location of the envelope so that the electronic display may display information based on the location of the electronic envelope. In alternative embodiments, a transceiver at a carrier location may provide the electronic envelope with its location if the electronic envelope is detected by the transceiver so that the electronic display on the envelope may display information based on the location of the envelope.

The carrier may handle the electronic envelope based on information displayed on the electronic display. In other embodiments, the carrier may handle the electronic envelope based on information selectively displayed on the electronic display. And in yet other embodiments, the carrier may handle the electronic envelope based on information selectively displayed on the electronic display according to instructions provided by the carrier computer. Furthermore, the carrier may sort the electronic envelope at a carrier location based on information displayed on the electronic display, on information selectively displayed on the electronic envelope, or on information selectively displayed on the electronic display according to instructions provided by the carrier computer. Additionally, the carrier may deliver the electronic envelope to a destination based on information displayed on the electronic display, on information selectively displayed on the electronic envelope, or on information selectively displayed on the electronic display according to instructions provided by the carrier computer.

According to various embodiments of the present disclosure, a system for shipping an item using an electronic envelope may include an electronic envelope, in which the electronic envelope includes an enclosure for shipping an item, a long-range communications chip fixed to the enclosure that is configured to receive shipping information related to the electronic envelope, an updateable electronic display fixed to the enclosure that is configured to display shipping information received by the long-range communications chip, and a microcomputer chip fixed to the enclosure that is connected to the long-range communications chip and to the updateable electronic display and that is configured to receive shipping information from the long-range communications chip and to selectively display the shipping information on the updateable electronic display to facilitate handling of the envelope. Also, a system may include a carrier computer that is configured to store shipping information and to communicate with the long-range communications chip on the electronic envelope to provide the long-range communications chip with shipping information to be displayed on the updateable electronic display. In some embodiments, the long-range communications chip may comprise a cellular chip.

In various embodiments, the microcomputer chip may be further configured to display on the updateable electronic display only the shipping information required for handling the electronic envelope at a particular location based on the presence of the electronic envelope at the particular location. In other embodiments, the microcomputer chip may be further configured to receive from the long-range communications chip all shipping information required for shipment of the electronic envelope, store the shipping information, and selectively display the shipping information on the updateable electronic display according to instructions provided by the carrier computer to the long-range communications chip and communicated to the microcomputer chip. In even other embodiments, the microcomputer chip may be further configured to receive from the long-range communications chip all shipping information required for shipment of the electronic envelope, store the shipping information, sort the shipping information in chronological order according to the shipping itinerary, and sequentially display the chronologically-sorted shipping information on the updateable electronic display according to instructions provided by the carrier computer to the long-range communications chip and communicated to the microcomputer chip. In yet other embodiments, the microcomputer chip may be further configured to cause the updateable electronic display to display content personalized for the recipient of the electronic envelope in response to delivery of the envelope to the recipient.

Additionally, according to various embodiments, the microcomputer chip may be further configured to store shipping information in an encrypted form and to selectively decrypt the shipping information prior to displaying the shipping information on the updateable electronic display. In other embodiments, the microcomputer chip may be further configured to store personal information of at least a sender or a recipient of the electronic envelope in an encrypted form and to selectively decrypt the personal information prior to displaying the personal information on the updateable electronic display. Even more, the microcomputer chip may be further configured to store destination information related to the electronic envelope in an encrypted form and to selectively decrypt the destination information prior to displaying the destination information on the updateable electronic display.

In other embodiment, the microcomputer chip may be further configured to alter destination information that is to be displayed on the updateable electronic display according to instructions provided by the carrier computer to the long-range communications chip if the destination of the electronic envelope is altered after a shipping order has been placed by a sender. Additionally, the microcomputer chip may be further configured to alter destination information that is to be displayed on the updateable electronic display according to instructions provided by the carrier computer to the long-range communications chip if the destination of the electronic envelope is altered after the destination information provided in a shipping order has been provided by the carrier computer to the long-range communications chip.

In even more embodiments, the carrier computer may be further configured to cause the microcomputer chip to selectively display the shipping information on the updateable electronic display according to instructions provided by the carrier computer to the long-range communications chip and communicated to the microcomputer chip. Also, the carrier computer may be further configured to cause the microcomputer chip to display on the updateable electronic display only the shipping information required for handling the electronic envelope at a particular location based on the presence of the electronic envelope at the particular location. Additionally, the carrier computer may be further configured to cause the microcomputer chip to receive from the long-range communications chip all shipping information required for shipment of the electronic envelope, store the shipping information, and selectively display the shipping information on the updateable electronic display according to instructions provided by the carrier computer to the long-range communications chip and communicated to the microcomputer chip. Even more, the carrier computer may be further configured to cause the microcomputer chip to receive from the long-range communications chip all shipping information required for shipment of the electronic envelope, store the shipping information, sort the shipping information in chronological order according to the shipping itinerary, and sequentially display the chronologically sorted shipping information on the updateable electronic display according to instructions provided by the carrier computer to the long-range communications chip and communicated to the microcomputer chip. Moreover, the carrier computer may be further configured to sort all shipping information required for shipment of the electronic envelope in chronological order according to the shipping itinerary prior to transmitting shipping information to the long-range communications chip and to cause the microcomputer chip to receive from the long-range communications chip the chronologically sorted shipping information required for shipment of the electronic envelope, store the shipping information, and sequentially display the chronologically sorted shipping information on the updateable electronic display according to instructions provided by the carrier computer to the long-range communications chip and communicated to the microcomputer chip

In other embodiments, the carrier computer may further configured to cause the microcomputer chip to display on the updateable electronic display content personalized for the recipient of the electronic envelope if the electronic envelope has been delivered to the recipient. Additionally, the carrier computer may be further configured to transmit shipping information to the long-range communications chip in periodic intervals, beginning with the placement of a shipping order. Moreover, the carrier computer may be further configured to transmit shipping information to the long-range communications chip if the long-range communications chip determines that the electronic envelope is at a carrier location. Also, the carrier computer may be further configured to transmit shipping information to the long-range communications chip if the long-range communications chip utilizes a global positioning system (GPS) chip included in the long-range communications chip to determine that the electronic envelope is at a carrier location. Plus, the carrier computer may be further configured to transmit shipping information to the long-range communications chip if the long-range communications chip utilizes a global positioning system (GPS) chip included on the enclosure to determine that the electronic envelope is at a carrier location. In addition, the system may further include a transceiver at a carrier location that is configured to communicate with the electronic envelope to provide the electronic envelope with its location if the electronic envelope is detected by the transceiver, so that the updateable electronic display on the electronic envelope can display information based on the location of the electronic envelope.

In yet other embodiments, the carrier computer may be further configured to transmit shipping information to the long-range communications chip if the shipping information is updated in the carrier computer by a sender of the electronic envelope. Also, the carrier computer may be further configured to transmit shipping information to the long-range communications chip if the shipping information is updated in the carrier computer by a destined recipient of the electronic envelope

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is an overall diagram and flow of a system for shipping an item using an electronic envelope;

FIGS. 2-3 describe process flows of the overall diagram and flow of the system for shipping an item using an electronic envelope;

FIG. 4 is a detailed view of an electronic envelope;

FIG. 5 is a depiction of a carrier computer communicating with a communications chip on an electronic envelope;

FIG. 6 depicts a GPS network updating a carrier computer and its mobile shipping application with a current location of an electronic envelope;

FIG. 7 is a detailed view of a sender computing device;

FIGS. 8A-8F illustrate various displays of shipping and handling information that an electronic display may be prompted to present;

FIGS. 9-11B describe process flows related to an electronic envelope;

FIGS. 12A-12B depict two methods (manual v. automated) by which a mobile shipping application executed by a carrier computer may obtain unique identifier data of an electronic envelope;

FIGS. 13A-13H, 13J-13M illustrate various screens generated by a carrier computer system by running a mobile shipping application, which screens are transmitted to a carrier computer throughout an envelope shipment process;

FIGS. 14-16 describe process flows related to a carrier computer's execution of a mobile shipping application;

FIG. 17 is a detailed view of a carrier computer; and

FIG. 18 describes a process flow of a shipping database and a web server of a carrier computer.

### DETAILED DESCRIPTION OF THE DRAWINGS

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like numbers refer to like elements throughout.

### DEFINITIONS

“Electronic envelope,” as used herein, may refer to an envelope that may include a communications chip for receiving shipping information related to the envelope and an updateable display for displaying the shipping information.

“Electronic paper,” as used herein, may refer to any type of updateable electronic display, whether black and white or color, such as Gyricon, which is licensed for manufacture by Xerox Corporation, electrophoretic display, electrowetting display, liquid crystal display (LCD), bistable LCD, electronic paper display, or any similar type of updateable electronic display. An electronic paper display may further include displays such as electrochromic displays, printed electronic displays, or displays manufactured using organic electronics or plastics electronics and using materials such as conductive polymers, plastics, and small molecules.

“Database,” as used herein, may refer to a physical entity that can store data. A database, for example, may be one or more of the following: a data store, a relational database, a table, a file, a list, a queue, a heap, and so on. A database may reside in one physical entity and/or may be distributed between two or more physical entities.

The programs and data used by the systems described herein, such as a mobile shipping application executed by a carrier computer, may be stored on a computer readable medium. The medium may include, but is not limited to, an ASIC, a CD, a DVD, a RAM, a ROM, a PROM, a disk, a carrier wave, a memory stick, and the like. Thus, an example computer readable medium can store computer executable instructions for allowing a sender to place a shipping order through a computing device such as a mobile device, laptop, desktop computer/workstation, and other similar devices.

“Mobile device,” as used herein, may refer to a mobile communications device through which a sender may place a shipping order. A mobile device, for example, may be one or more of the following: a cellular phone, a personal digital assistant (PDA), a handheld device that is capable of accessing a web-based/remote version of a mobile shipping application, and the like.

### System Overview:

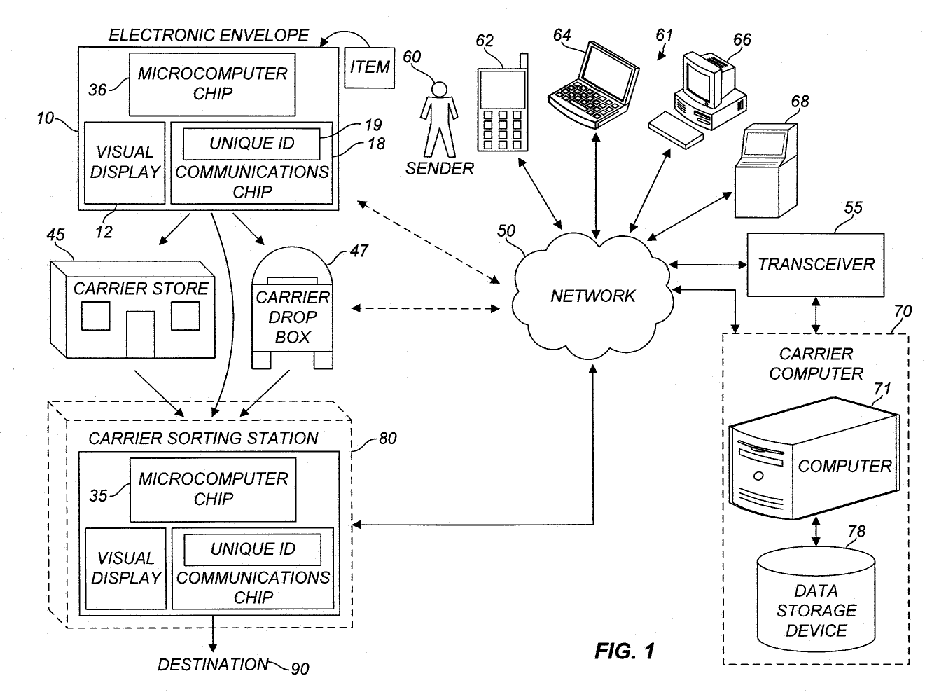

This system, according to various embodiments, enables a sender to ship an item in an electronic envelope from a location where a sender has access to a carrier's mobile shipping application. With reference to FIG. 1, some embodiments of an electronic envelope 10 may include a communications chip 18 for receiving shipping information related to the envelope 10, unique identifier data 19 associated with the communications chip 18 that may serve as a unique identifier for the envelope 10, and an updateable display 12 for displaying the shipping information. Other embodiments of an electronic envelope 10 may also include a microcomputer chip 36 for translating shipping information into a format suitable for display on an updateable display 12 and then transmitting the reformatted information to an updateable display 12. Even more embodiments may include a power supply for providing power to a communications chip 18, a flexible electronic visual display 12, or a microcomputer chip 36. Alternative embodiments may include a power switch to allow a microcomputer chip 36 to selectively activate a flexible electronic visual display 12. In various embodiments of an envelope 10, a communications chip 18 may be a long range communications chip, such as a cellular chip or a radio transceiver. A cellular chip may contain tie number data that may serve as a unique identifier for an envelope 10. In still other embodiments, a communications chip 18 may comprise an RFID tag. An RFID tag may contain RFID tag number data that may serve as a unique identifier for an envelope 10. Furthermore, other embodiments of an envelope 10 may include a GPS chip for providing a carrier with a location of the envelope 10 prior to shipment, during shipment, and after delivery.

To ship an electronic envelope 10, a sender 60 may place a shipping order through a carrier's mobile shipping application. A mobile shipping application may reside on a carrier computer 70 and may be accessed through a computing device 61, such as a mobile device 62, laptop computer 64, desktop computer/workstation 66, kiosk 68, or similar device, that may be able to access the carrier computer 70 via a communications network 50. For example, a mobile shipping application may be a JAVA- or ASP-based application executed by a carrier computer 70 to provide at least the functionality described herein. Components of a mobile shipping application may also reside on a computing device 61, such as a client or script transferred to a computing device 61 by a carrier computer 70 via a communications network 50. The components may permit the mobile shipping application to interact with the carrier computer 70 via a network interface and a sender 60 via a sender interface. Alternatively, a mobile shipping application may reside locally on a computing device 61. Shipping orders may include unique identifier data of an electronic envelope or an alias or pointer to such unique identifier data.

In response to a sender 60 placing a shipping order through a mobile shipping application, the shipping order may be transmitted from a computing device 61 to a carrier computer 70 via a network 50. The network 50 which may be a wireless communications network, a wide-area network (WAN), a local area network (LAN), or other communications network. A carrier computer 70 may include at least one computer 71 that may be configured to run a mobile shipping application. A carrier computer 70 may also include a data storage device 78 that may be connected to the least one computer 71 of the carrier computer 70. Once an order is received by a carrier computer 70, it may store the order internally or in a carrier shipping database contained in a data storage device 78, may assign a tracking number to the order, and may transmit the tracking number along with a confirmation to a computing device 61, among other functions.

After a sender 60 places a shipping order, the sender 60 may deposit, or cause to be deposited through an agent or assistant, for example, an electronic envelope 10 at a carrier location. The carrier location may include, for example, a carrier store 45, a carrier drop location 47, or a carrier sorting station 80. A carrier may consolidate envelopes 10 at an intake hub of the carrier's transportation and logistics network. At the intake hub, the envelopes 10 may be sorted for further transportation and delivery. An intake hub may include a carrier sorting station 80 or a like location.

Additionally, after a sender 60 has placed a shipping order, a carrier computer 70 may provide shipping information to an electronic envelope 10 at various times throughout the shipping process so that the electronic envelope 10 may display the shipping information on an updateable electronic display 12. In some embodiments, a carrier computer 70 may provide shipping information to an electronic envelope 10 prior to the time when the envelope 10 arrives at a carrier location or is introduced to a carrier sorting process. Thus, an electronic envelope 10 may already contain the shipping information required for sorting, handling, and shipping the envelope 10 to its final destination 90 or to any intermediate destination. In other embodiments, a carrier computer 70 may provide shipping information to an electronic envelope 10 in periodic intervals, beginning with the placement of a shipping order.

In yet other embodiments, a carrier computer 70 may provide shipping information to an electronic envelope 10 upon its introduction to a carrier's logistics network. In response to an electronic envelope 10 being introduced to a carrier's logistics network at an intake hub, sorting station, or other carrier location, a carrier may employ a transceiver 55 to detect the presence of the electronic envelope 10 and to read unique identifier data 19 from a communications chip 18 on the envelope 10 and forward the unique identifier data 19 to a carrier computer 70. A transceiver 55 may reside at a carrier intake hub, in a carrier sorting station 80, at the same location where a carrier computer 70 resides, or in any other location from where the transceiver 55 may be able to detect a communications chip 18 on an electronic envelope 10 and may be connected with a carrier computer 70, either directly or via a network, in order to be able to transmit information between a carrier computer 70 and a communications chip 18 on an electronic envelope 10. A carrier computer 70 may use received unique identifier data 19 to retrieve shipping information associated with the unique identifier data 19 and may provide the shipping information to the envelope 10 by transmitting the information to a communications chip 18 on the envelope 10. To provide information to a communications chip 18, a transceiver 55 may transmit the information from a carrier computer 70 across a communications network 50 to the communications chip 18.

In embodiments in which a communications chip 18 is a cellular chip, a carrier may employ a broadband transceiver, or similar device, as the transceiver 55, in order to detect the presence of the electronic envelope 10 and to read tie number data from a cellular chip on the envelope 10 and forward the tie number data to a carrier computer 70. A carrier computer 70 may use received tie number data to retrieve shipping information associated with the tie number data 19 and may provide the shipping information to the envelope 10 by transmitting the information to a cellular chip on the envelope 10. To provide information to a cellular chip, a broadband transceiver may transmit the information from a carrier computer 70 across a communications network 50 to the cellular chip.

In even other embodiments, in which a communications chip 18 is an RFID tag, carrier may employ am RFID reader/writer, or similar device, as the transceiver 55, in order to detect the presence of the electronic envelope 10 and to read RFID tag number data from and RFID tag on the envelope 10 and forward the RFID tag number data to a carrier computer 70. A carrier computer 70 may use received RFID tag number data to retrieve shipping information associated with the RFID tag number data 19 and may provide the shipping information to the envelope 10 by transmitting the information to an RFID tag on the envelope 10. To provide information to an RFID tag, an RFID reader/writer may transmit the information from a carrier computer 70 across a communications network 50 to the RFID tag.

Additionally, in other embodiments, an electronic envelope's address may be updated or changed at various points after a shipping order has been placed, including any time after a sender 60 has relinquished the electronic envelope 10 to a carrier, any time during transport of an electronic envelope 10 in a carrier's logistics network, or any other time after a sender 60 has placed a shipping order to send the electronic envelope 10, thus providing the sender 60, carrier, or receiver with greater control over shipping and handling of the electronic envelope 10 even after the envelope 10 has entered the carrier's logistics network. In order to update or change a destination address during transport, a sender may use a sender computing device 61 to access a mobile shipping application that is running on the sender computing device 61, carrier computer 70, or both, to update or change the destination address or other shipping-related information, and the sender computing device 61, carrier computer 70, or both, may execute the mobile shipping application to transfer the updated or changed destination address and shipping-related information to the carrier computer 70. A receiver, if authorized by a sender, may update or change a destination address or shipping-related information using a computing device in a similar manner. A carrier may also update or change a destination address or handling instructions via the at least one computer 71 or a computing device 61 in response to workload at a hub, distribution routes, delay or interruption due to weather, labor shortage, power outage, or other reason.

If a destination address or other shipping-related information is updated after a shipping order has been placed, a carrier computer 70 may be configured to transmit the updated shipping information to a related electronic envelope 10 in order for the updated information to be displayed on an updateable electronic display 12. Additionally, a microcomputer chip 36 on an electronic envelope 10 may be configured to receive updated shipping information via a communications chip 18 and update an updateable electronic display 12 based on the updated shipping information, accompanying instructions provided by a carrier computer 70, or any combination of the two.

A carrier computer 70 may be configured to provide various amounts of shipping information to an electronic envelope 10 each time that the carrier computer transmits shipping information to an electronic envelope 10. A carrier computer 70 may provide all of the shipping information required for the package to be sorted, handled, and shipped to its final destination. On the other hand, a carrier computer 70 may provide only the shipping information necessary for the electronic envelope 10 to be sorted, handled, and shipped to its next, immediate destination 90. Additionally, a carrier computer 70 may provide any amount of shipping information in between the entire required shipping information and the minimum necessary shipping information. Further, a carrier computer 70 transmission of shipping information may include instructions for components on an electronic envelope 10 to utilize in determining what shipping information to display on an updateable electronic display 12 and when to display the shipping information. In yet other embodiments, shipping information provided from a carrier computer 70 to an electronic envelope 10 may be encrypted, and therefore may not be displayed on an updateable electronic display 12 until decrypted. Even more, a carrier computer may sort shipping information in chronological order according to the shipping itinerary prior to transmitting the shipping information to an electronic envelope 10.

In various embodiments, if shipping information has been transmitted from a carrier computer 70 to an electronic envelope 10, the shipping information may reside in one or more of a communications chip 18, a microcomputer chip 36, an updateable electronic display 12, or other component on an electronic envelope 10. If shipping information resides in a communication chip 18, the communications chip 18 may either transmit shipping information to an updateable electronic display 12 or transmit shipping information to a microcomputer chip 36, among other options. If the communications chip 18 transmits shipping information to a microcomputer chip 36, the microcomputer chip 36 may facilitate, enable, manage, or any combination of those functions, among others, the display of the shipping information on an updateable electronic display 12. Among other functions, a microcomputer chip 36 may be configured to translate shipping information into a format that is capable of being displayed on an updateable electronic display 12.

A microcomputer chip 36 may display shipping information on an updateable electronic display 12 in either a static or dynamic presentation, or a combination of both. When displaying shipping information in a static presentation, a microcomputer chip 36 may display either one static image that includes shipping information or may display sequential static images of shipping information, each sequential image including at least some shipping information different from the shipping information on the previous image. In embodiments in which a microcomputer chip 36 displays shipping information on an updateable electronic display 12 through the display of one static image, the microcomputer chip 36 may display the shipping information on an updateable electronic display 12 at any point during the transport of an electronic envelope 10 after a shipping order has been placed. In embodiments in which a microcomputer chip 36 may display shipping information on an updateable electronic display 12 through the display of sequential static images, the microcomputer chip 36 may display the images containing shipping information on an updateable electronic display 12 at various points throughout the transport of an electronic envelope 10, from the time a shipping order has been placed all the way until after an electronic envelope 10 has been delivered to its final destination 90.

In embodiments in which a microcomputer chip 36 may display shipping information on an updateable electronic display 12 through the display of sequential static images, a microcomputer chip 36 may be configured to receive and store shipping information related to more than one image. In such embodiments, a microcomputer chip 36 may be configured to selectively display shipping information on an updateable electronic display 12, based on a number of factors or conditions.

In some embodiments, a microcomputer chip 36 may be configured to selectively display shipping information on an updateable electronic display 12 based on either instructions configured into the microcomputer chip 36, instructions provided by a carrier computer 70, or a combination of both. In these embodiments, instructions may instruct a microcomputer chip 36 to display on an updateable electronic display 12 only information required for handling, sorting, and shipping an electronic envelope 10 at a particular location if the microcomputer chip 36 receives an indication that the electronic envelope 10 is at that particular location.

In such embodiments in which location of an electronic envelope 10 is a factor, shipping information displayed based on a particular location of an electronic envelope 10 may facilitate the shipping process at that particular location or at subsequent locations to which the electronic envelope 10 is destined. In these embodiments, the microcomputer chip 36 must receive information that indicates the location of the electronic envelope 10. In some embodiments, a microcomputer chip 36 may receive location information from a GPS chip 31 that may be included on an electronic envelope 10. In other embodiments, a microcomputer chip 36 may receive location information from a GPS chip 31 that may be included in a communications chip 18 on an electronic envelope 10. In yet other embodiments, a microcomputer chip 36 may receive location information, via a communications chip 18, from either a sender computing device 61, carrier computer 70, or both, that has received a transmission from a GPS chip 31 on the electronic envelope 10 that indicates the location of the electronic envelope 10. In still other embodiments, a transceiver 55 or other device at a carrier intake hub, sorting station, or similar location, may provide a microcomputer chip 36, via a communications chip 18, with the location of an electronic envelope 10.

For example, a microcomputer chip 18 may be configured to selectively display on an updateable electronic display 12 a final destination address for an electronic envelope 10 if the microcomputer chip receives an indication, based on the location of the electronic envelope 10, that the electronic envelope 10 has been placed on a delivery truck and that the next destination of the electronic envelope 10 is the final destination of the electronic envelope 10. Additionally, a microcomputer chip 18 may be configured to selectively display on an updateable electronic display 12 content personalized for the recipient of said electronic envelope 10 in response to delivery of said envelope 10 to said recipient. In another example, a microcomputer chip 36 may be configured to selectively display on an updateable electronic display 12 sort destination within a carrier sorting station, or similar location, if the microcomputer chip 36 receives an indication, based on the location of the electronic envelope 10, that the electronic envelope 10 is at a carrier sorting station and that the next destination of the electronic envelope 10 is the conveyor address displayed on the updateable electronic display 12.

In yet other embodiments in which a microcomputer chip 36 may be configured to selectively display shipping information on an updateable electronic display 12 based on either instructions configured into the microcomputer chip 36, instructions provided by a carrier computer 70, or a combination of both, a microcomputer chip 36 may be further configured to sort the shipping information in chronological order according to the shipping itinerary, and sequentially display the chronologically sorted shipping information on said updateable electronic display according to either instructions provided either by the carrier computer 70, instructions configured into the microcomputer chip 36, or a combination of both. In yet other alternative embodiments, a carrier computer 70 may be configured to sort shipping information prior to transmitting the shipping information to a microcomputer chip 36, via a transceiver 55 and a communications chip 18, and the carrier computer 70 may cause the microcomputer chip 36 to receive said shipping information, store the shipping information, and sequentially display the chronologically sorted shipping information on said updateable electronic display according to either instructions provided either by the carrier computer 70, instructions configured into the microcomputer chip 36, or a combination of both.

In other embodiments in which a microcomputer chip 36 may display shipping information on an through the display of sequential static images and the microcomputer chip 36, the microcomputer chip 36 may be configured to receive shipping information at each successive location at which the updateable electronic display 12 is to be updated. In such embodiments, shipping information may be provided by a carrier computer 70 to a microcomputer chip 36, via a transceiver 55 and a communications chip 18, at each successive location, and the microcomputer chip 36 may update an updateable electronic display 12 with the received shipping information. In still other embodiments in which a microcomputer chip 36 may display shipping information on an through the display of sequential static images and the microcomputer chip 36, the microcomputer chip 36 may be configured to receive shipping information through a combination of methods, including receiving and storing shipping information related to more than one image and receiving shipping information at each successive location at which the updateable electronic display 12 is to be updated.

Furthermore, in various embodiments, a carrier computer 70 may be configured to instruct a microcomputer chip 18 to selectively display on an updateable electronic display 12 content personalized for the recipient of said electronic envelope 10 in response to delivery of said envelope 10 to said recipient. The content may comprise a message to from the sender, a message from the carrier, an advertisement by the carrier or a third party, or any other content that is capable of being displayed on an updateable electronic display 12.

Shipping information may be encrypted to preserve privacy in relation to a sender 60 and receiver and in relation to contents of an electronic envelope 10. Such a feature may be useful in a variety of contexts, for instance, diplomatic, governmental, corporate, or personal information that may be desired to be preserved in secrecy. In various embodiments, a carrier computer 70 may be configured to encrypt shipping information prior to transmitting the shipping information to an electronic envelope. In other embodiments, a microcomputer chip 36 may be configured to encrypt shipping information upon receipt of the shipping information from a carrier computer 70 via a transceiver 55 and a communications chip 18. All types of shipping information may be encrypted, including destination information that may include any destination to which an electronic envelope 10 is scheduled to be transported, personal information that may include the name, address, payment information, and other personal information of a sender 60 or a receiver of an electronic envelope, and any other shipping-related information that may be transmitted to an electronic envelope 10.

In order to display encrypted shipping information on an updateable electronic display 12, the shipping information may first be decrypted. In some embodiments, a microcomputer chip 36 may be configured to decrypt encrypted shipping information prior to display of the shipping information on an updateable electronic display 12. In other embodiments, a transceiver 55 at an intake hub may be configured to provide a decryption key, via a communications chip 18, to a microcomputer chip 36 in order for the microcomputer chip to decrypt encrypted shipping information prior to display of the shipping information on an updateable electronic display 12. In yet other embodiments, a carrier computer 70 may provide a decryption key, via a communications chip 18, to a microcomputer chip 36 in order for the microcomputer chip to decrypt encrypted shipping information prior to display of the shipping information on an updateable electronic display 12. In alternative embodiments, a carrier computer 70 may provide a decryption key to a microcomputer chip 36 via a transceiver 55 and a communications chip 18.

Shipping information may be decrypted in a number of manners. In some embodiments, a microcomputer chip 36 may decrypt all of the shipping information prior to displaying any shipping information on an updateable electronic display 12. In other embodiments, a microcomputer chip 18 may selectively decrypt only the shipping information that the microcomputer chip 18 is next going to display on the updateable electronic display 12.

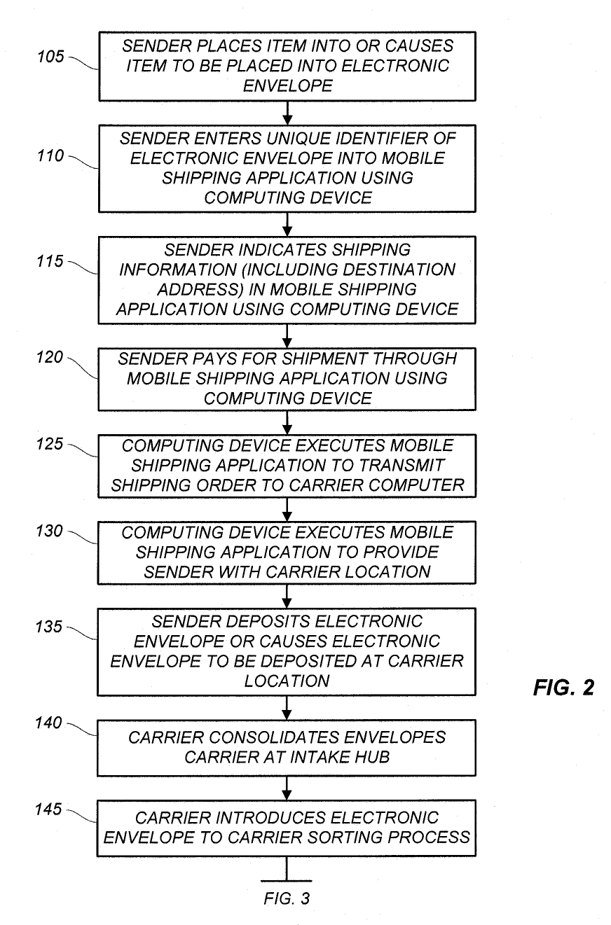

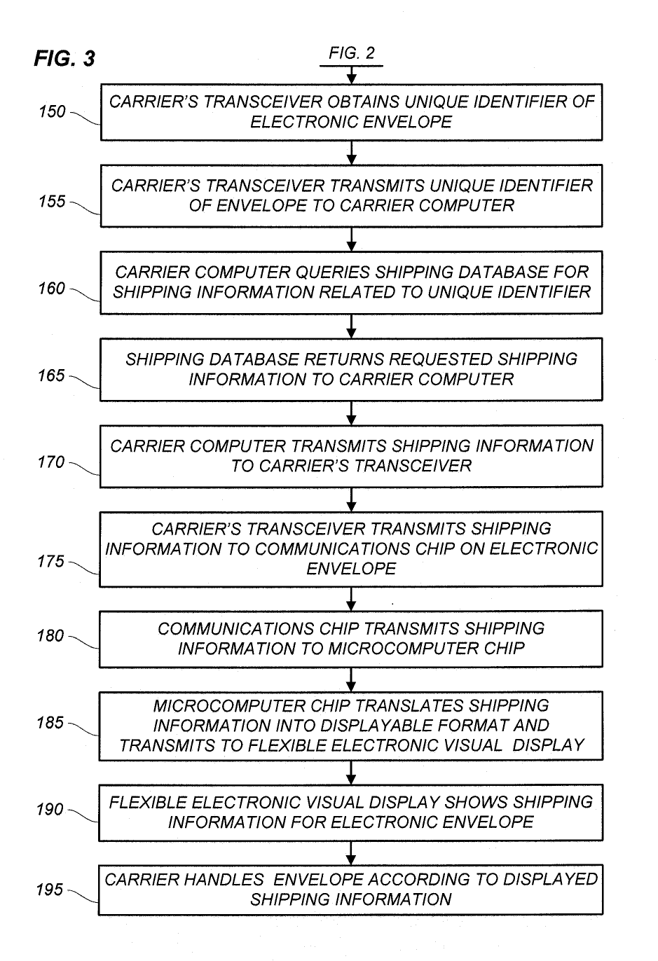

FIG. 2 depicts a process flow related to an embodiment of an overall system for shipping an item using an electronic envelope. In Step 105, a sender may place an item into or may cause an item to be placed into an electronic envelope. In Step 110, a sender may initiate a shipping order through use of a mobile shipping application running on a sender computing device, a carrier computer, or both, by entering unique identifier data of the electronic envelope or causing unique identifier data to be entered into a mobile shipping application via a sender computing device. In Step 115, a sender inputs shipping information, including a destination address, into a mobile shipping application and in Step 120 pays for the shipment through the mobile shipping application via a sender computing device. In Step 125, a sender computing device may execute a mobile shipping application to transmit a shipping order to a carrier computer and in Step 130 provides a sender with a carrier drop location where the sender may deposit an electronic envelope. In Step 135, a sender may deposit an electronic envelope or may cause the electronic envelope to be deposited at a carrier location, and in Step 140, a carrier may consolidate envelopes at a carrier intake hub. In Step 145, a carrier may introduce an electronic envelope to a carrier sorting process.

Continuing to FIG. 3, once an electronic envelope has been introduced to a sorting process, in Step 150, the carrier's transceiver may obtain unique identifier data of the electronic envelope and in Step 155 may transmit the unique identifier data of the envelope to a carrier computer. In Step 160, a carrier computer may query a data storage device hosting a shipping database for shipping information related to the unique identifier data, and the data storage device may retrieve shipping information associated with the unique identifier data from the shipping database. In Step 165, a data storage device may return the requested shipping information to a carrier computer. In step 170, a carrier computer may transmit the shipping information to a transceiver, and in Step 175, the transceiver may transmit the information to a communications chip. In Step 180, a communications chip may transmit shipping information to a microcomputer chip, and in Step 185, the microcomputer chip may transmit the shipping information to a flexible electronic visual display on an electronic envelope. In Step 190, shipping information may be displayed on a flexible electronic visual display, and in Step 195, a carrier ships and handles an envelope according to the shipping information visible on the flexible electronic visual display.

### Electronic Envelope:

FIG. 4 represents a detailed depiction of components of an electronic envelope 10, according to various embodiment of the invention. In some embodiments, components of an electronic envelope 10 may include a flexible electronic visual display 12, a microcomputer chip 36, a GPS chip 31, a power supply 40, a power switch 42, and a communications chip, among other components. A communications chip may be a long range communications chip, such as a cellular chip 20 or a radio transceiver, an RFID tag 25, or any other similar communications device. A long-range communications chip may be a communications chip that has the ability to send communications to or receive transmissions from distances of at least one mile. Components may be connected to each other by any number of methods, including wired, wireless, optical connections, or other types of connections. In some embodiments, components are connected to each other via at least one motherboard. The motherboard may be any type of motherboard and may use any form factor, including, but not limited to, ATX and FlexATX. In other embodiments, components are connected to each other via various types of cabling or wiring, including, but not limited to, flex cabling and silicon flex cabling. In embodiments that employ cabling or wiring to connect components on an electronic envelope 10, the cabling or wiring may serve as a medium by which the components may communicate with each other. Additionally, in embodiments in which components on an electronic envelope 10 are connected to a power supply 40, cabling, wiring, at least one motherboard, or any combination, therein, may be utilized to provide power to components that may require power.

A communications chip, which is represented in FIG. 4 as a cellular chip 20 or an RFID tag 25, may be connected to a microcomputer chip 36 in order to transmit shipping information to a microcomputer chip 36 so that the information may be translated into a format that may be capable of being displayed on a flexible electronic visual display 12. A flexible electronic visual display 12 may be connected to a microcomputer chip 36 so that the display 12 may receive shipping information that is to be displayed. A microcomputer chip 36 may be connected to both a communications chip and a flexible electronic visual display 12 so that the microcomputer chip 36 may receive shipping information from the communications chip, translate the information into a format that may be capable of being displayed on the flexible electronic visual display 12, and transmit the translated shipping information to the flexible electronic visual display 12 so that the information may be displayed.

A flexible electronic visual display 12 may include an interface 17, memory 14, a processor 15, a graphics adapter 16, and a display 13, among other components, all connected to a bus, as represented in FIG. 4. A graphics adapter 16 may include a microprocessor; however, a graphics adapter 16 may not be a necessary component of a flexible electronic visual display 12, as a processor 15 may possess the ability to perform the functions of a graphics adapter. A flexible electronic visual display 12 may be one of many types of visual display devices, including electronic paper or other similar devices.

In embodiments in which a communications chip is a cellular chip 20, the cellular chip 20 may include a processor 23, an interface 24, memory 21, and unique tie number data 22 or MAC address data, among other elements. A processor 23, interface 24, and memory 21 may all be connected to a bus, and tie number data 22 may be programmed into the memory 21. Tie number data 22 may serve as unique identifier data for an electronic envelope 10. A cellular chip 20 may be capable of communicating in one or more cellular communications protocols, including, but not limited to, CDMA, W-CDMA, GSM, UMTS, 3G, Evolved 3G, HSDPA, and other protocols. A cellular chip 20 may interface with a carrier's broadband transceiver in order to receive shipping information related to an electronic envelope 10 for display on a flexible electronic visual display 12.

In other embodiments, in which a communications chip is an RFID tag 25, an RFID tag 25 may include a processor 28, a transceiver 29, memory 26, and unique RFID tag number data 27. A processor 28, a transceiver 29, and memory 26 may all be connected to a bus, as represented in FIG. 4, and RFID tag number data 27 may be programmed into the memory 26. RFID tag number data 27 may serve as unique identifier data for an electronic envelope 10. A transceiver 29 may send information to and receive information from an RFID reader/writer.

A microcomputer chip 36 may include a processor 38, memory 39, and at least one interface 37. A processor 38, memory 39, and at least one interface 37 may all be connected to a bus, as represented in FIG. 4. A microcomputer chip 36 may be capable of receiving a transmission from a communications chip 20 or a radio transmission from an RFID tag 25, either of which may contain shipping information related to an electronic envelope 10, and translating the transmission into a format that may be capable of being displayed on a flexible electronic visual display 12. A microcomputer chip 36 may be one of many types of microcomputer chips, microprocessor chips, microcontroller chips, or the like, made from a number of manufacturers, including Hitachi and Toshiba.

A GPS chip 31 may include a processor 34, at least one interface 35, memory 32, and a GPS identifier 33. A GPS identifier 33 may be programmed into the memory 32, and the GPS identifier 33 may serve as the unique identifier by which the GPS chip 31 may be identified. A GPS chip 31 may be any standard GPS device that is capable of obtaining its position and transmitting the position across a network to any of a plurality of devices, such as a GPS network, a computing device, a mobile device, or any other device that may be configured to receive a GPS signal. A GPS

A power supply 40 may be one of many types of power supplies, including a battery, a power sheet, photoelectric cell, and the like. In some embodiments, a preferred power supply 40 may comprise nanocomposite paper developed by Rensselaer Polytechnic Institute that may be used to manufacture batteries. The batteries manufactured from the nanocomposite paper may be lightweight, flexible, and ultra-thin. Nevertheless, power supplies that are not lightweight, flexible, and ultra-thin may also be utilized in an electronic envelope 10.

A power switch 42 may be any switch that may change the flow of the current or voltage applied by a power supply 40 to a flexible electronic visual display 12. A power switch 42 may be selectively activated by a microcomputer chip 36 in order to provide power to illuminate a flexible electronic visual display 12. A microcomputer chip 36 may be configured to activate a power switch 42 at various points during the shipping process, including, but not limited to, immediately after a shipping order is placed and transmitted to a communications chip 20 on an envelope 10, in response to an envelope 10 arriving at a carrier sorting station, in response to an envelope 10 passing through a carrier sorting process, in response to an envelope 10 arriving at an intermediate shipping facility, or in response to an envelope 10 arriving at a terminal shipping facility for delivery to a final destination.

According to embodiments of the present invention, components of an electronic envelope 10 may be connected to each other in various manners. A communications chip may be connected to (1) a power supply 40 in order to receive power and to (2) a microcomputer chip 36 in order to transmit shipping information to the microcomputer chip 36 so that the information may be translated into a format that may be capable of being displayed on a flexible electronic visual display 12. In FIG. 4, a communications chip is depicted as a cellular chip 20 or an RFID tag 25. Both a cellular chip 20 and an RFID tag 25 may be connected to a microcomputer chip 36, but an RFID tag may not be connected to a power supply 40 as an RFID tag 25 may receive power from one or more other sources. A flexible electronic visual display 12 may be connected at least to (1) a microcomputer chip 36 so that the display 12 may receive shipping information that may be displayed and to (2) a power switch 42 that may be selectively activated for the purpose of providing power to the display 12. A microcomputer chip 36, may be connected at least to (1) a communications chip and to (2) a flexible electronic visual display 12 so that the microcomputer chip 36 may receive shipping information from the communications chip, translate the information into a format that may be capable of being displayed on the flexible electronic visual display 12, and transmit the translated shipping information to the flexible electronic visual display 12 so that it may be displayed. Additionally, a microcomputer chip 36 may be connected at least to (3) a power switch 42 to enable the microcomputer chip 36 to selectively activate the power switch 42 for the purpose of providing power to a flexible electronic visual display 12. An RFID tag 25 may be connected to a microcomputer chip 36 in order to transmit shipping information to the microcomputer chip 36 so that the information may be translated into a format that may be capable of being displayed on the flexible electronic visual display 12. A GPS chip 31 may be connected to a power supply 40 in order to receive power. A power supply 40 may be connected at least to (1) a flexible electronic visual display 12, (2) a communications chip, (3) a microcomputer chip 36, (4) a GPS chip 31, and (5) a power switch 42 that may be selectively activated by the microcomputer chip 36 for the purpose of providing power to the flexible electronic visual display 12.

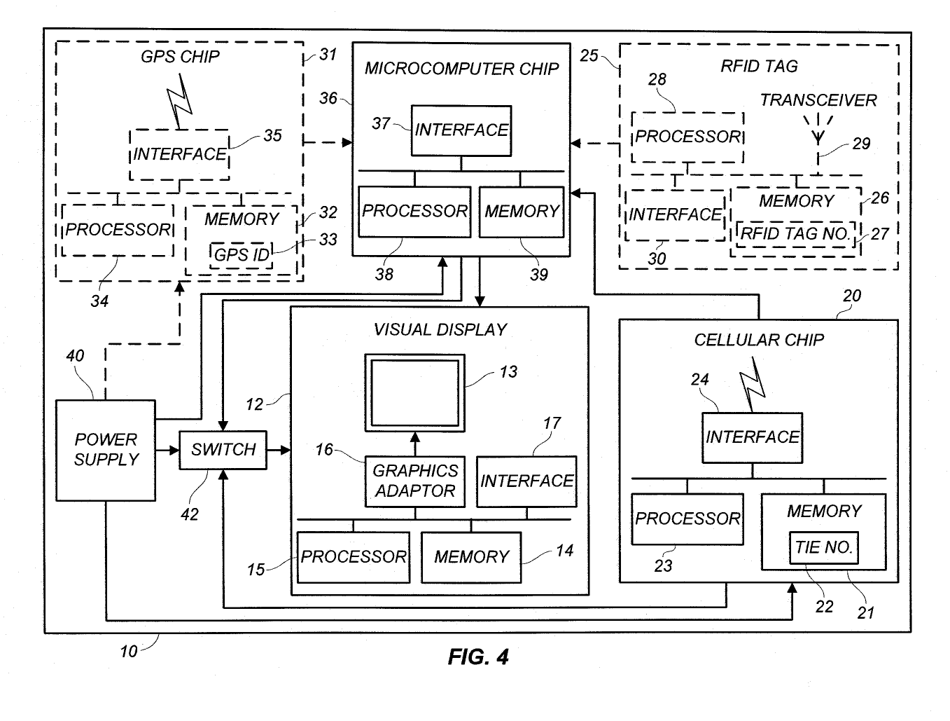

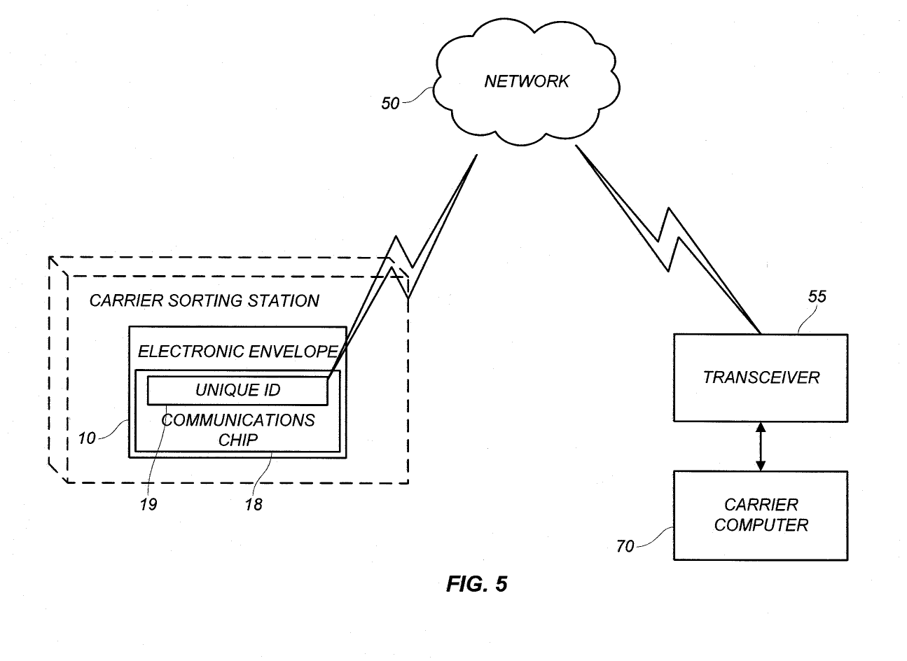

FIG. 5 is an illustration of carrier computer 70 providing shipping information to an electronic envelope 10. In order for a carrier computer 70 to provide shipping information to an electronic envelope 10, a carrier computer 70 may communicate with a communications chip 18 via a transceiver in order to obtain unique identifier data 19 of the electronic envelope 10. A communications chip 18 may be a cellular chip, RFID tag, or other similar device. In embodiments in which a cellular chip is employed, a carrier computer 70 may retrieve tie number by transmitting a request or command for a cellular chip to transmit unique tie number data. Alternatively, a cellular chip may be configured to transmit tie number to a carrier computer 70 upon detecting it is in the presence of or within range of a transceiver 55. In embodiments in which a cellular chip is employed, a transceiver 55 may be a broadband transceiver or similar device. A cellular chip may transmit tie number to a carrier's broadband transceiver via a communications network 50. A broadband transceiver may transfer tie number to a carrier computer 70, and a carrier may return shipping information associated with the tie number to the broadband transceiver. A broadband transceiver may then transfer shipping information to a cellular chip via a communications network 50.

In other embodiments, an electronic envelope may receive shipping information through the use of an RFID tag that may be contained on the envelope. In embodiments in which an RFID tag is employed, a transceiver 55 may be an RFID reader/writer or similar device. In order for a carrier computer 70 to provide shipping information to an RFID tag, an RFID reader/writer may obtain RFID tag number data of an electronic envelope and may transmit the RFID tag number data to a carrier computer 70 via a WAN, LAN, wireless network, or any data communications network. A carrier computer 70 may transmit shipping information associated with unique identifier data to an RFID reader/writer via a data communications network, and the RFID reader/writer may transmit the information to an RFID tag on an electronic envelope.

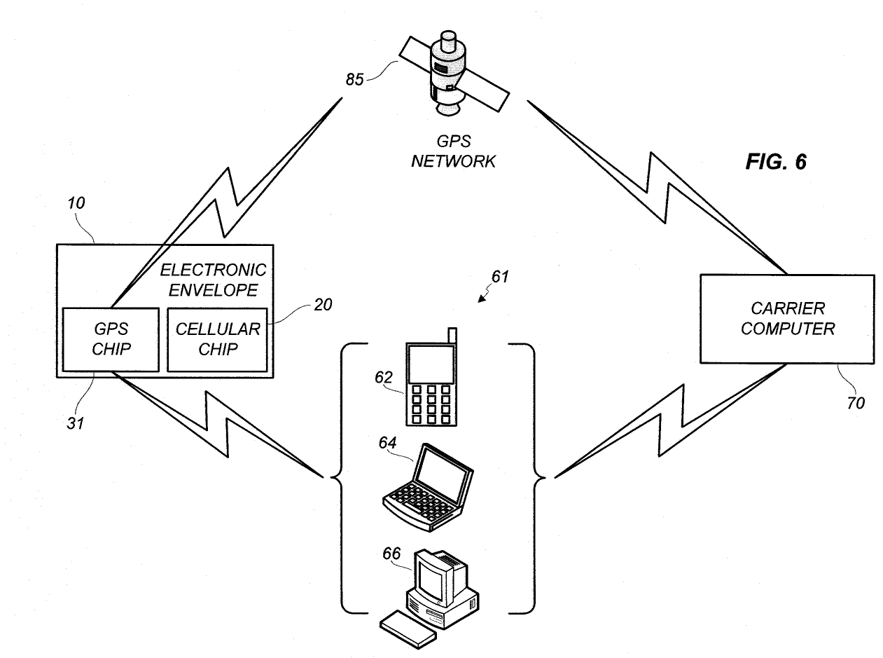

FIG. 6 depicts a GPS network 85 updating a carrier computer 70 and a mobile shipping application with the current location of an electronic envelope 10. A GPS network 85 may provide a GPS chip 31 on an electronic envelope 10 with the current location of the GPS chip 31 (also known as, the location of the electronic envelope 10). A GPS chip 31 may use this location information to provide a sender computing device 61, which may include a mobile device 62, laptop computer 64, desktop computer/workstation 66, kiosk 68, or similar device, with the location of an electronic envelope 10 so that a mobile shipping application executed on a carrier computer 70, or sender computing device 61, or both, may determine the nearest carrier location. Alternatively or additionally, a GPS network 85 may provide a carrier computer 70 with the current location of an electronic envelope 10 so that a mobile shipping application executed on a carrier computer 70, or sender computing device 61, or both, may determine the nearest carrier location. A carrier computer 70 may maintain location information so that a sender may track an electronic envelope 10 throughout its shipment. In other embodiments, a GPS chip 31 may be included in a communications chip 18, such as a cellular chip, or other component on an electronic envelope 10 rather than be a standalone component on an electronic envelope 10, or a GPS chip 31 may be partially a standalone component and partially included at least one other component on an electronic envelope 10.

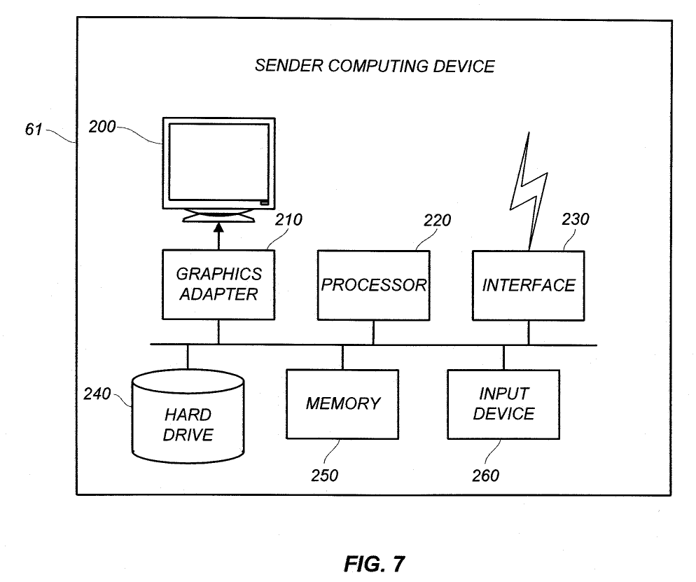

FIG. 7 illustrates an embodiment of a sender computing device 61. A sender computing device 61 may include a display device 200, a graphics adapter 210, a processor 220, at least one interface 230, a hard drive 240, memory 250, and at least one input device 260, among other components. A graphics adapter 210 may include a microprocessor; however, a graphics adapter 210 may not be a necessary component of a display device 200 as a processor 220 may possess the ability to perform the functions of a graphics adapter. A display device 200 may be a mobile device screen, a laptop screen, desktop computer/workstation screen integrated with a desktop/workstation, a standalone computer monitor, or any display device that is capable of displaying a mobile shipping application executed by a carrier computer. An input device 260, which may allow a sender computing device 61 to receive data from a sender, may include any of a number of devices that allow a sender computing device 61 to receive data, such as a keypad, a touch display, or other input device. In embodiments that include a keypad, the keypad may include the conventional numeric (0-9) and related keys (e.g., #, *) and other keys used for operating a sender computing device 61. A keypad may further include alphabetical characters associated with conventional numeric and related keys. Alternatively, a keypad may include a conventional QWERTY keypad arrangement. A keypad may also include various soft keys with associated functions. In addition, or alternatively, a sender computing device 61 may include an input device such as a joystick, mouse, or other user input device. An interface 230 may include a component that is capable of communicating over a wireless communications network, a wide-area network (WAN), a local area network (LAN), or other communications network. Additionally, a sender computing device 61 may be configured to run a mobile shipping application, among other functions.

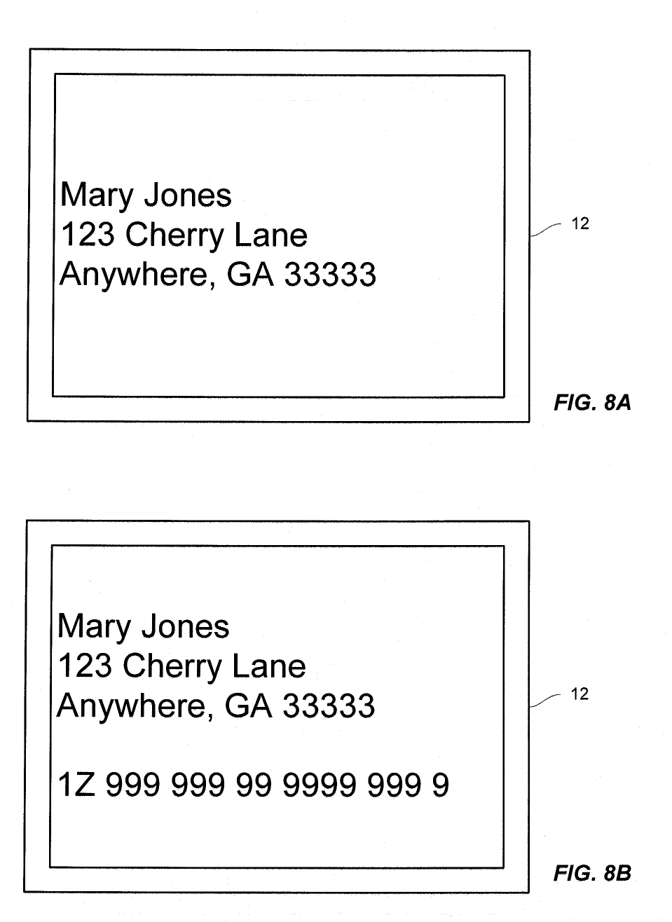

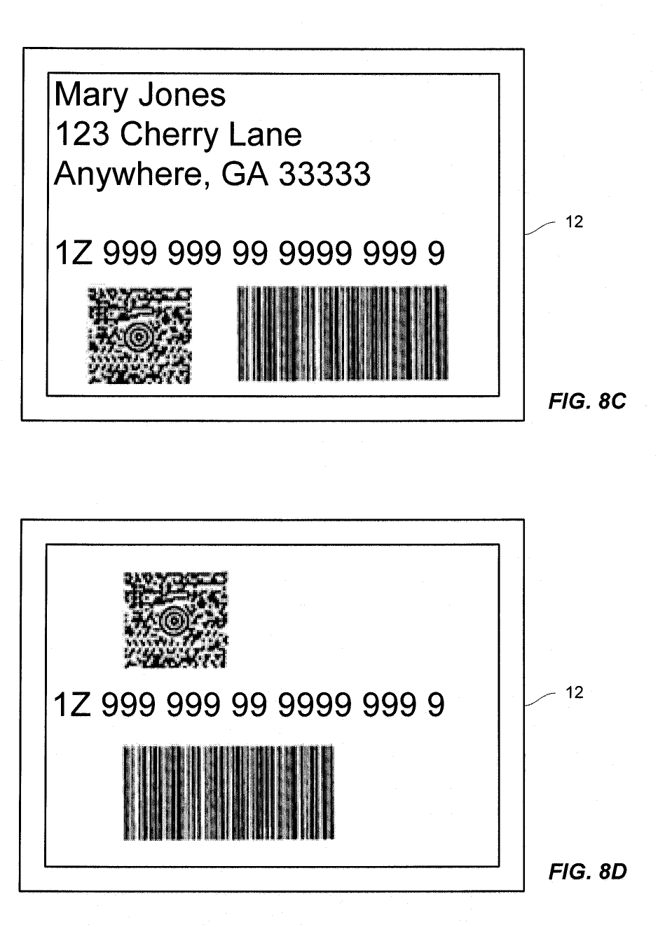

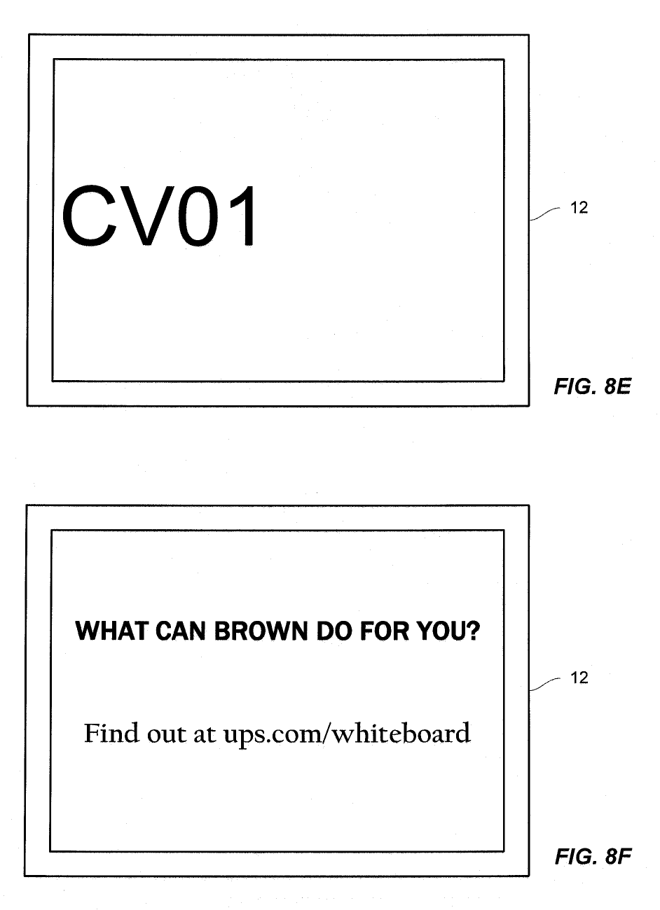

FIGS. 8A-8F depict various exemplary displays of a flexible electronic visual display 12. FIGS. 8A-8F demonstrate that the quantity and type of information displayed on a flexible electronic visual display 12 of an electronic envelope may be selective based on the amount of information to be displayed and the equipment and capabilities of the sorting equipment and handlers at a sorting location within the carrier's logistics network, among other factors. FIG. 8A shows only a destination address of an electronic envelope. FIG. 8B shows a destination address along with a tracking number of an electronic envelope. Tracking numbers are well known in the industry and may be used to track and manage shipments. FIG. 8C depicts a destination address, a tracking number, a barcode, and a MaxiCode. Barcodes are well known in the industry and are machine readable representations of information. Barcodes may contain shipping information, including a tracking number, and may be used to track and manage shipments. MaxiCode is a public domain, machine readable system that was originally created by United Parcel Service, Inc. A MaxiCode symbol may include a tracking number and may be employed to track and manage shipments. Each of the various pieces of information displayed on a flexible electronic visual display 12 may serve as a primary tracking mechanism, a secondary tracking mechanism, or both. FIG. 8D shows a MaxiCode, the tracking number, and a barcode, without a destination address. Each of the various identification and tracking mechanisms that are displayed in FIGS. 8A-8D may or may not be displayed on a flexible electronic visual display 12 on an electronic envelope, and the mechanisms may be displayed either independently or in any combination with each other. FIG. 8E displays information pertaining to the handling of an electronic envelope or package within a carrier facility. “CV01,” for example, may indicate conveyor number 01 within a sorting facility. Any sorting, handling, or related information may be displayed on a flexible electronic visual display 12. FIG. 8F displays an advertisement on a flexible electronic visual display. In other embodiments, available bandwidth that is unused during transmissions between a carrier broadband transceiver and a communications chip on an electronic envelope may be leveraged to display, for example, pictures, mobile video, and email, and other images and videos. Thus, an electronic envelope may serve as a video e-card with video images displayed on a flexible electronic visual display on the envelope.

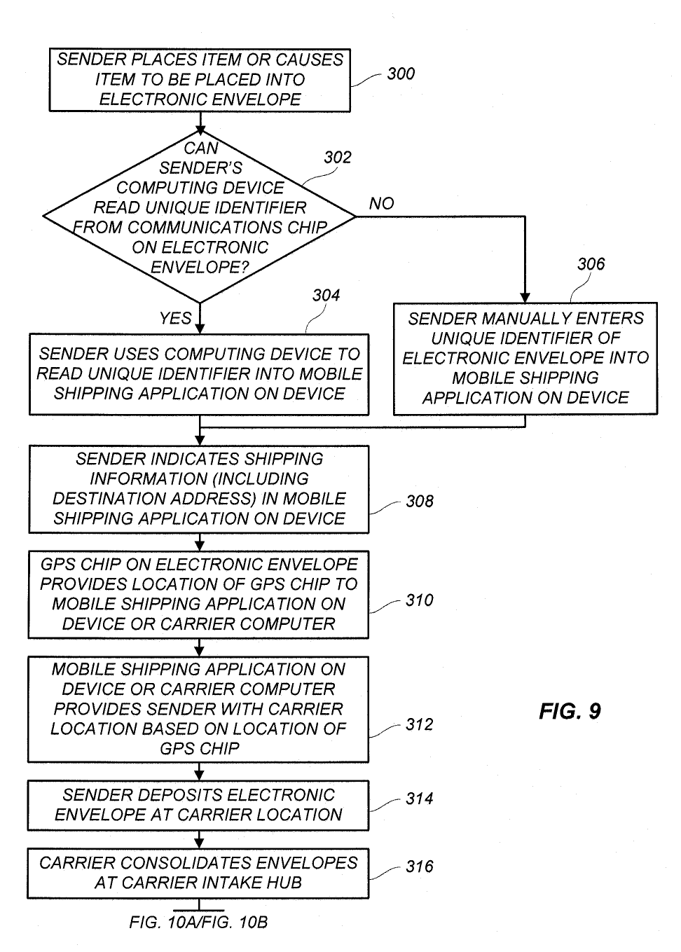

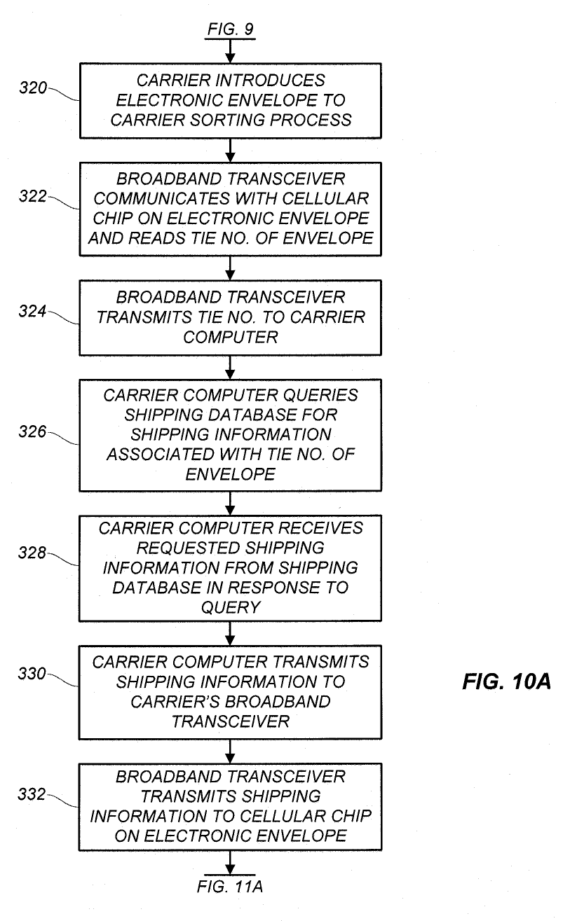

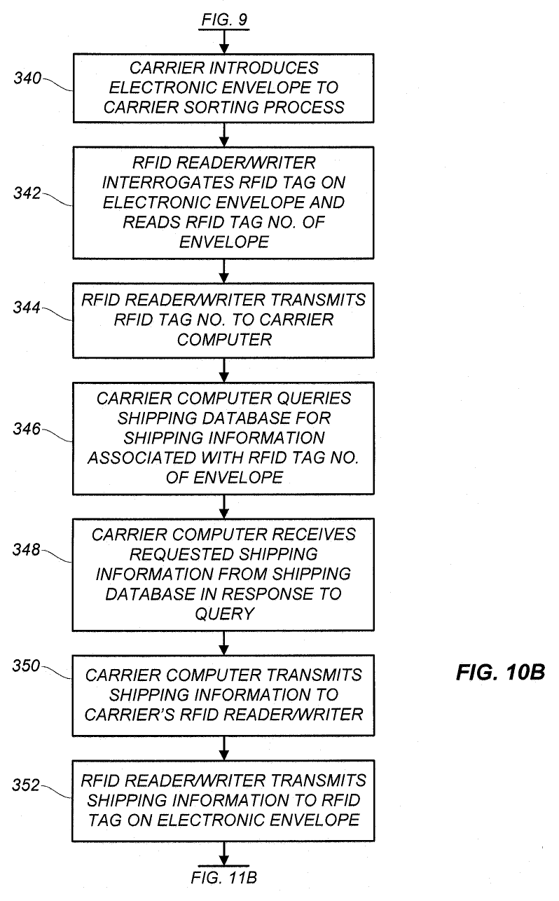

FIG. 9 illustrates a process flows related to an electronic envelope. In Step 300, a sender places an item into or causes an item to be placed into an electronic envelope. In Step 302, a sender computing device executes a mobile shipping application, causing the device to determine whether it can read unique identifier data from a communications chip on an electronic envelope. Based on this determination, either a sender computing device may read unique identifier data into a mobile shipping application running on the sender computing device in Step 304 or a sender may manually enter unique identifier data into a mobile shipping application running on a sender computing device in Step 306. In Step 308, a sender may indicate shipping information for an electronic envelope, including a destination address, into a mobile shipping application. In Step 310, a GPS chip on an electronic envelope or a GPS chip contained in a communications chip on an envelope may receive a transmission from a GPS network that may indicate the location of the GPS chip. In Step 312, a GPS chip may transmit the location (e.g., GPS coordinates) to a sender computing device, and a mobile shipping application running on either a carrier computer, sender computing device, or both, provides a sender with a carrier location based on the location of the GPS chip. Alternatively, a sender computing device may transmit a received location to a carrier computer, which may respond with one or more carrier locations in the vicinity of the GPS coordinates so that a sender may transport an envelope to such a carrier location. In Step 314, a sender may deposit an envelope or cause an envelope to be deposited at a carrier location, and in Step 316, a carrier may consolidate envelopes at a carrier intake hub.

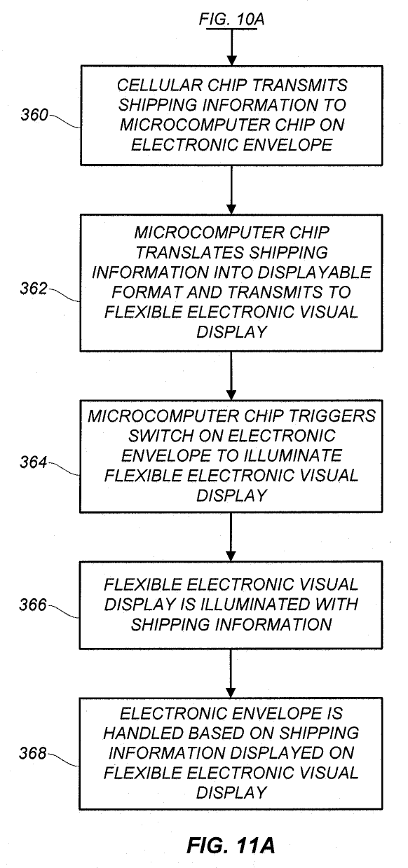

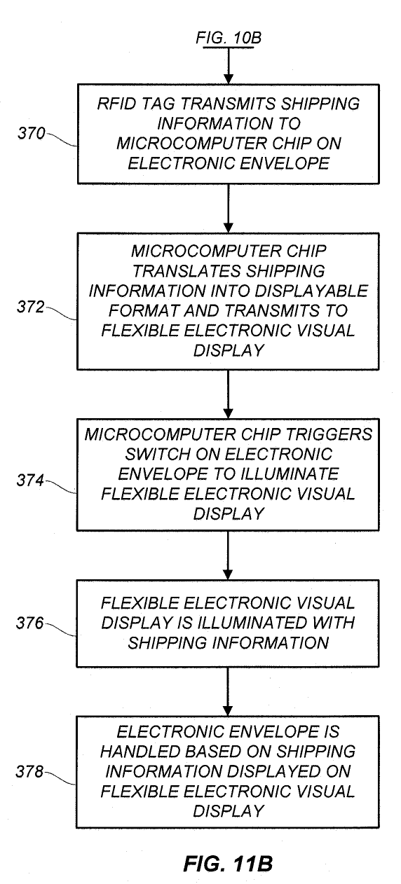

FIG. 10A depicts a carrier sorting process flow in which an electronic envelope may be updated through a cellular chip. In Step 320, a carrier may introduce an envelope to a carrier sorting process. In Step 322, a broadband transceiver may communicate with a cellular chip on an electronic envelope, may obtain unique identifier data of the envelope, and in Step 324 may provide the unique identifier data to a carrier computer. A broadband transceiver may communicate with a cellular chip across a wireless communications network. In Step 326, a carrier computer may query a shipping database for shipping information associated with unique identifier data of an electronic envelope. In Step 328, a carrier computer may receive requested shipping information from a shipping database in response to a query, and the carrier computer may format the information for transmission across a wireless communications network. In Step 330, a carrier computer may provide reformatted information to a broadband transceiver, and in Step 332, the broadband transceiver may transmit the reformatted shipping information to a cellular chip on an electronic envelope via a wireless communications network.

FIG. 10B depicts a carrier sorting process flow in which an electronic envelope may be updated through an RFID tag. In Step 340, a carrier may introduce an envelope to a carrier sorting process. In Step 342, an RFID reader/writer may interrogate an RFID tag on an electronic envelope and may obtain unique identifier data of the envelope. In Step 344, an RFID reader/writer may transmit unique identifier data to a carrier computer across a wireless communications network, WAN, LAN, or any communications network. In Step 346, a carrier computer may query a shipping database for shipping information associated with unique identifier data of an envelope. In Step 348, a carrier computer may receive requested shipping information from a shipping database in response to a query. In Step 350, a carrier computer may transmit shipping information to an RFID reader/writer across a communications network. In Step 352, a RFID reader/writer may then transmit shipping information to an RFID tag on an electronic envelope.

FIG. 11A depicts a process flow by which a flexible electronic visual display may be updated from a cellular chip on an electronic envelope. Before performance of the process flow of FIG. 11A, a cellular chip may have received, via a communications network, shipping information from a carrier computer that a sender may have associated with an electronic envelope via unique identifier data of the envelope. In Step 360, a cellular chip may transmit shipping information to a microcomputer chip on an electronic envelope. In Step 362, a microcomputer chip may translate shipping information into a format that may be displayable on a flexible electronic visual display and may transmit reformatted shipping information to the flexible electronic visual display on an electronic envelope. In Step 364, a microcomputer chip may activate a power switch on an electronic envelope to illuminate a flexible electronic visual display. In Step 366, a display may be activated and may show shipping information related to an electronic envelope, and in Step 368, an envelope may be shipped and handled according to shipping information visible on a flexible electronic visual display.

FIG. 11B depicts a process flow by which a flexible electronic visual display may be updated from an RFID tag on an electronic envelope. Before performance of the process flow of FIG. 11B, an RFID tag may have received, via a communications network, shipping information from a carrier computer that a sender may have associated with an electronic envelope via unique identifier data of the envelope. In Step 370, an RFID tag may transmit shipping information to a microcomputer chip on an electronic envelope. In Step 372, a microcomputer chip may translate shipping information into a format that may be displayable on a flexible electronic visual display and may transmit the reformatted shipping information to the flexible electronic visual display on an electronic envelope. In Step 374, a microcomputer chip may activate a power switch on an electronic envelope to illuminate a flexible electronic visual display. In Step 376, a display may be activated and may show the shipping information related to an electronic envelope, and in Step 378, an envelope may be shipped and handled according to shipping information visible on a flexible electronic visual display.

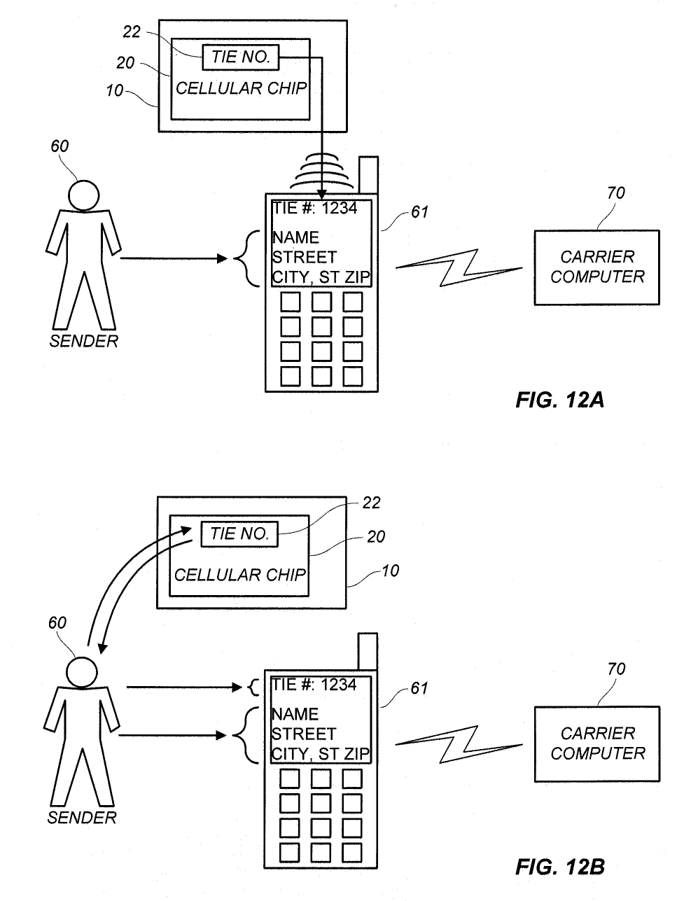

FIGS. 12A-12B depict two ways in which a mobile shipping application may obtain unique identifier data from an electronic envelope 10. In FIG. 12A, in which a communications chip is depicted as a cellular chip 20, a sender computing device 61, whether a mobile device 62, laptop computer 64, desktop computer/workstation 66, kiosk 68, or similar device, may be capable of communicating with a cellular chip 20 on an electronic envelope 10 to obtain tie number data 22 of the envelope 10. A sender computing device 61 may obtain tie number data 22 and may transmit the tie number data 22 to a mobile shipping application running on the sender computing device 61, carrier computer 70, or both. A sender computing device 61, carrier computer 70, or both, may execute a mobile shipping application to associate tie number data 22 with a shipping order and to transmit the tie number data 22 and the shipping order together to the carrier computer 70.

In FIG. 12B, a sender computing device 61, whether a mobile device 62, laptop computer 64, desktop computer/workstation 66, kiosk 68, or similar device, may not have the capability of communicating with a cellular chip 20 on an electronic envelope 10 to obtain tie number data 22 of the envelope 10. Instead, a sender 60 may manually indicate tie number data 22 into a mobile shipping application accessed via a sender computing device 61. A sender computing device 61, carrier computer 70, or both execute a mobile shipping application to associate tie number data with a shipping order and to transmit the tie number data 22 and the shipping order together to the carrier computer.

In alternative embodiments, a communications chip may be another type of chip, such as an RFID tag, and RFID tag number data may be used instead of tie number data as unique identifier data of an envelope. If a sender computing device, whether a mobile device, laptop, desktop/workstation, or similar device, is capable of interrogating an RFID tag on an electronic envelope to obtain RFID tag number data of the envelope, then the sender computing device may obtain the RFID tag number data of an envelope and may transmit the RFID tag number data to a mobile shipping application running on the sender computing device. A sender computing device may continue to execute a mobile shipping application to associate RFID tag number data with a shipping order and to transmit the RFID tag number data and the shipping order together to a carrier computer. If a sender computing device, whether a mobile device, laptop, desktop/workstation, or similar device, does not have the capability of communicating with an RFID tag on an electronic envelope to obtain RFID tag number data of an envelope, a sender may manually indicate the RFID tag number data into a mobile shipping application. A mobile shipping application may associate RFID tag number data with a shipping order and may transmit the RFID tag number data and the shipping order together to a carrier computer.

In alternative embodiments, unique identifier data may be transmitted to a carrier computer prior to being associated with a corresponding shipping order. In such embodiments, a carrier computer may receive unique identifier data, whether tie number data or RFID tag number data, and a corresponding shipping order from a mobile shipping application and may store the unique identifier data in association with the shipping order to associate the shipping order with the proper electronic envelope.

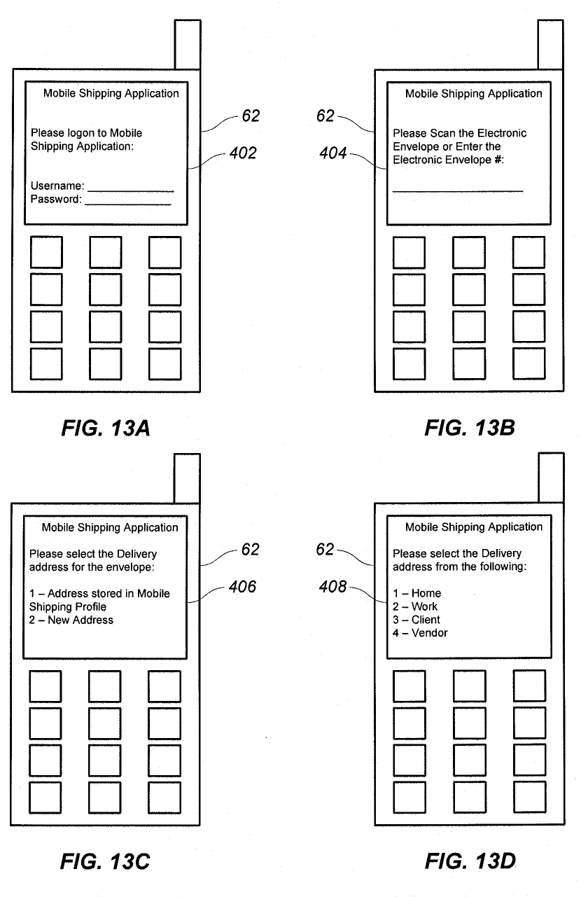

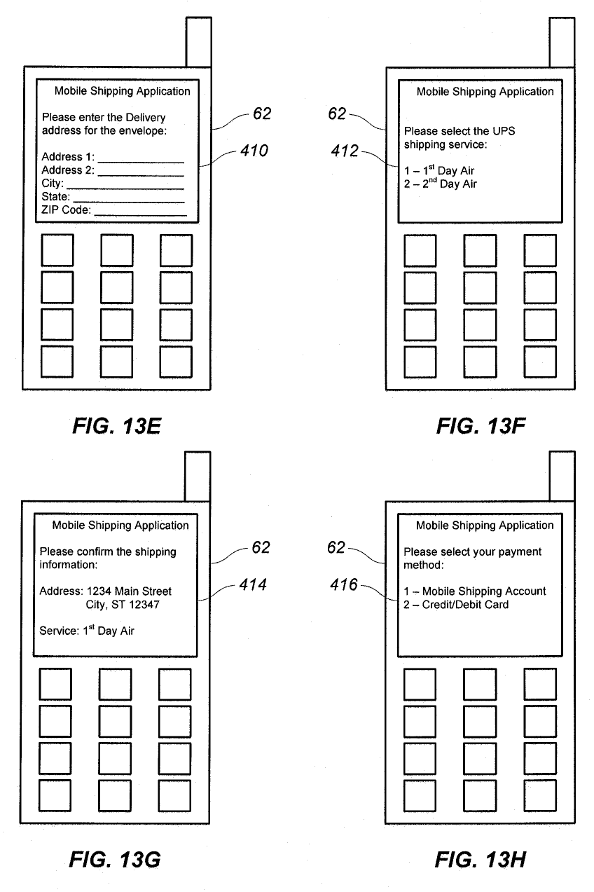

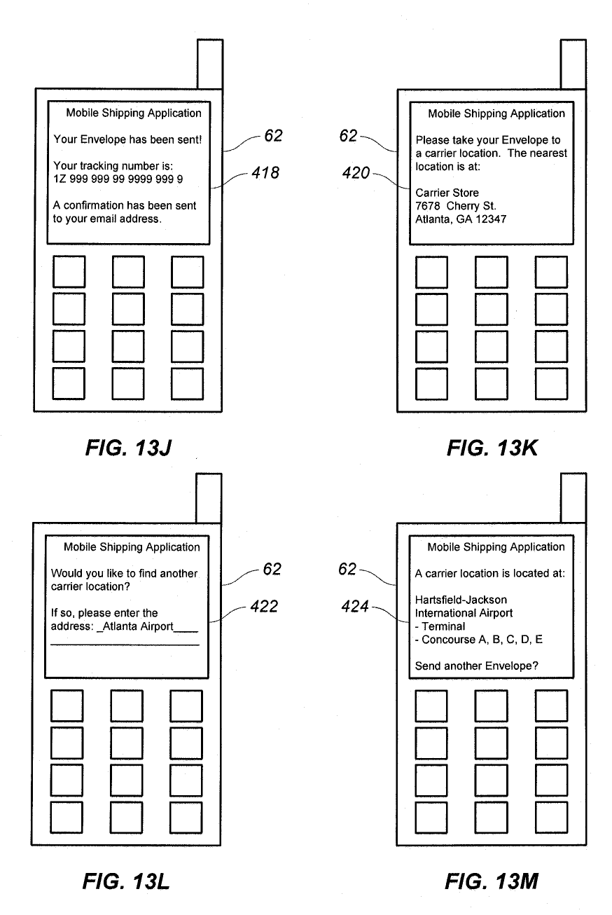

FIGS. 13A-13H, 13J-13M depict various screen prints of an embodiment of a mobile shipping application. FIGS. 13A-13H, 13J-13M depict a mobile shipping application on a mobile device; however, the mobile shipping application may be accessed from any mobile device, laptop, desktop computer/workstation, or similar device. A mobile shipping application may be a web-based or remote application that resides on a carrier computer and may be accessible through the internet or through a data communications network. Alternatively, a mobile shipping application may be a local application that is installed and run on a sender computing device that is capable of communicating with a carrier computer via a data communications network. A local application may serve as an interface for placing shipping orders or for accessing tracking information related to a shipment. Moreover, a mobile shipping application may be a combination of web-based/remote and local functionality.

FIG. 13A-13H, 13J-13M represent a series of screens depicting a method of using a mobile shipping application running on a sender computing device, a carrier computer, or both, in accordance with various embodiments. Specifically, FIGS. 13A-13H, 13J-13M illustrate an embodiment of a method in which a sender computing device 61 is a mobile device 62. However, a sender computing device 61 may also be a laptop computer 64, desktop computer/workstation 66, kiosk 68, or similar device.

In order to initiate a shipment through a mobile shipping application, a sender may login to a sender profile within the mobile shipping application. FIG. 13A depicts a login screen 402 through which a sender may login to a sender profile. A sender profile may store information such as sender personal contact information, addresses of sender contacts, preferred level of service, and account payment information, among other information. If a sender does not have a sender profile, a sender may be prompted by a mobile shipping application to create a profile. A sender may then create a profile; however, a mobile shipping application may allow the sender to place a shipping order without a sender profile.

Once a sender logs into a mobile shipping application or begins placing a shipping order without a sender profile, the sender may indicate unique identifier data for an electronic envelope. FIG. 13B shows a screen 404 in which a sender may indicate unique identifier data. The screen may be populated either manually by a sender or automatically if a sender computing device is capable of communicating with a communications chip on an envelope in order to obtain unique identifier data.

Also, a sender may indicate a shipping address for an electronic envelope. FIG. 13C illustrates a screen 406 in which a sender may indicate a shipping address. A sender may select an address from a sender profile stored in a mobile shipping application or the sender may enter a new address that is not stored in a sender profile. FIG. 13D shows a screen 408 in which a sender may select a shipping address from a list of contacts stored in a sender profile in a mobile shipping application. FIG. 13E depicts a screen 410 in which a sender may enter a shipping address that is not stored in a sender profile. The entered information may be stored in the sender's profile for availability the next time the sender decides to ship a package to that particular recipient.

In addition to indicating a shipping address, a sender may select a level of service for a shipment. FIG. 13F illustrates a screen 412 in which a sender may indicate a level of service. A level of service may be prepopulated by a mobile shipping application based on a preference saved in a sender profile.

Moreover, a sender may be provided with details of a shipping order so that the sender may confirm the shipping order. FIG. 13G depicts a screen 414 in which a sender may confirm a shipping information for a shipping order.

A sender may pay for a shipping order through a mobile shipping application, and the mobile application may provide the sender with a shipping order confirmation, a tracking number associated with the shipping order, or both. FIG. 13H shows a screen 416 in which a sender may select a method of payment. FIG. 13J illustrates a screen 418 in which a mobile shipping application may confirm that a shipping order has been placed and may provide a sender with a tracking number.

After placing an order, an envelope may be deposited at a carrier location. FIG. 13K shows a screen 420 in which a mobile shipping application may provide a sender with at least one nearby carrier location at which the sender may deposit an electronic envelope or may cause an electronic envelope to be deposited. A carrier location provided by a mobile shipping application may be based upon the location of a GPS chip located on an electronic envelope or a GPS chip contained in a communications chip on an electronic envelope.

A sender, however, may wish to deposit an envelope at an alternate carrier location. To obtain an alternate carrier location, a sender may indicate an address that the sender would like a mobile shipping application to use to identify nearby carrier locations. FIG. 13L illustrates a screen 422 in which a sender may indicate into a mobile shipping application that the sender would like to locate at least one different carrier location than a location automatically provided to the sender by the mobile shipping application.

If a sender indicates a desired location, a mobile shipping application may return at least one alternate carrier location. FIG. 13M depicts a screen 424 in which a mobile shipping application may return at least one carrier location near a location indicated by a sender.

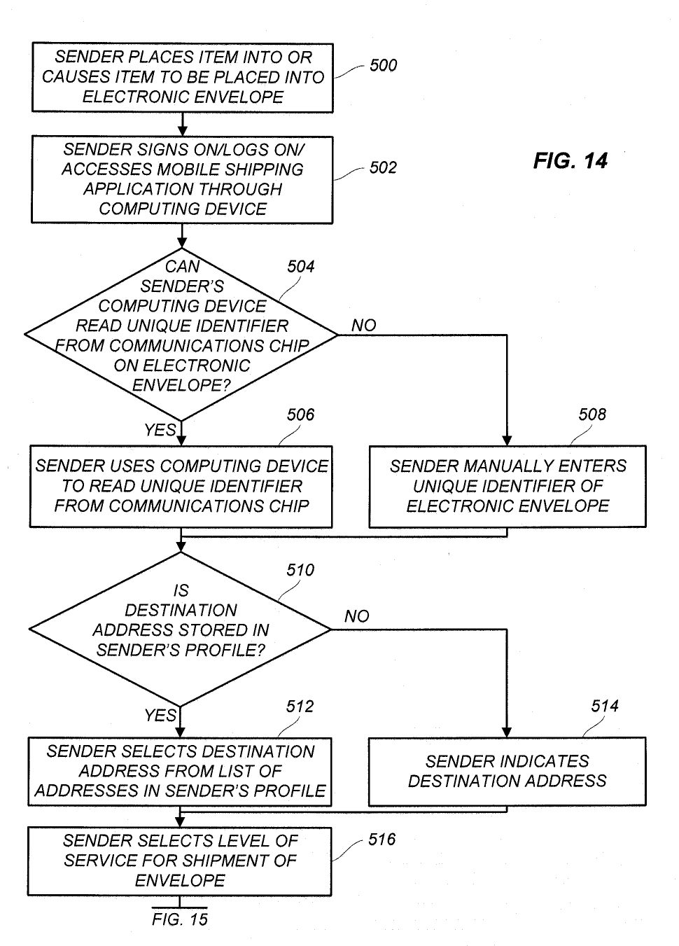

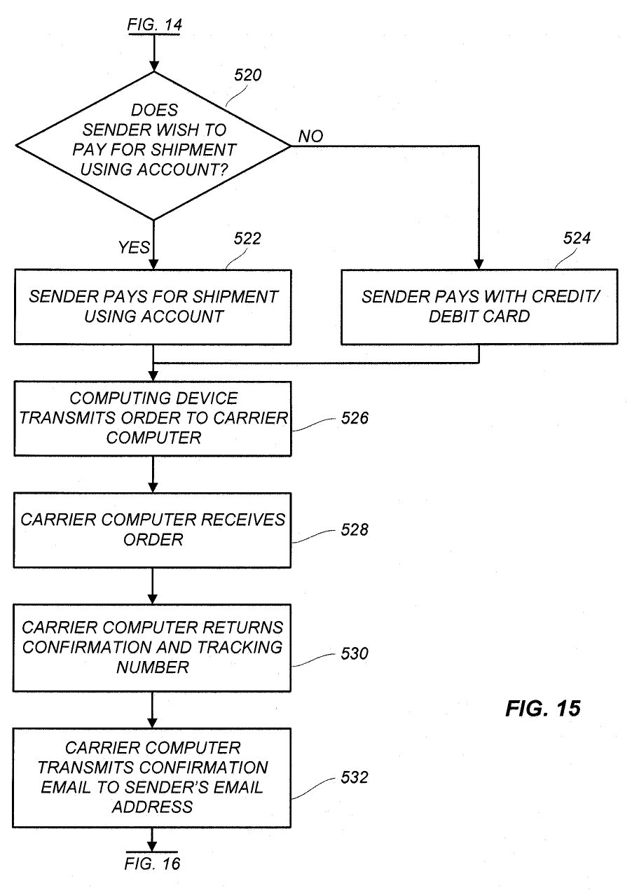

FIG. 14 illustrates a process flow, according to various embodiments, of a method of placing a shipping order using a mobile shipping application running on a sender computing device or a carrier computer. In Step 500, a sender may place an item in an electronic envelope or may cause an item to be placed into an electronic envelope. In Step 502, a sender may login to a mobile shipping application and may initiate a new shipping order. In Step 504, if a sender computing device, whether a mobile device, laptop, desktop/workstation, or similar device, is capable of communicating with a communications chip on an electronic envelope to obtain unique identifier data of the envelope, then in Step 506, a computing device may obtain unique identifier data and may transmit the unique identifier data to a mobile shipping application running on a computing device or a carrier computer. Otherwise, in Step 508, a sender may manually enter unique identifier data into a mobile shipping application via a sender computing device. In Step 510, a sender may determine if a destination address for an electronic envelope is stored in a sender's profile in a sender computing device or carrier computer. If a destination address is stored in a sender profile, in Step 512, a sender may select a destination address from a list of addresses stored in a sender profile. If a destination address is not stored in a sender profile, in Step 514 a sender may enter a destination into the mobile shipping application running on a computing device or a carrier computer. In Step 516, a sender may select a level of service for a shipping order.

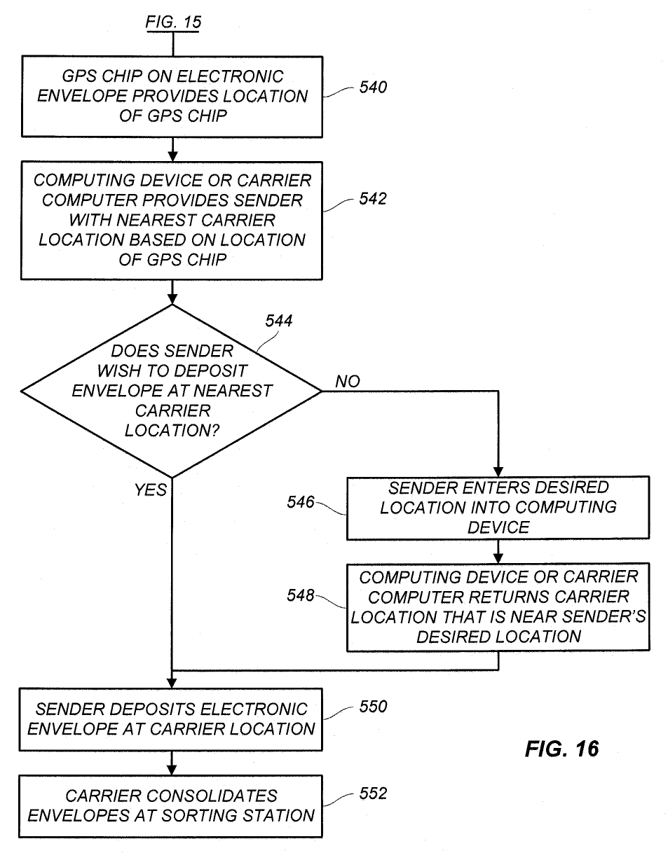

Continuing to FIG. 15, a sender may indicate a method of payment for a shipping order. If in Step 520 a sender decides to pay for a shipment using a sender account in the mobile shipping application, in Step 522, the sender may indicate this selection into the mobile shipping application via the sender computing device. If the sender wishes to pay with a credit/debit card, the sender may indicate the selection in Step 524 and may provide credit/debit card information into the mobile shipping application via a sender computing device. The mobile shipping application may be configured to operate a sender computing device to indicate another form of payment, including electronic check, for example. In Step 526, the sender computing device may execute the mobile shipping application to transfer a shipping order to a carrier computer. In Step 528, the carrier computer may receive a shipping order, in Step 530 may return a tracking number and confirmation to the mobile shipping application component running on the sender computing device, and in Step 532 may transmit a confirmation to an email address of the sender. A carrier computer may store a shipping order in a shipping database.

Further, continuing to FIG. 16, in Step 540, a GPS chip on an electronic envelope or a GPS chip contained in a communications chip on an electronic envelope may be continually updated with its present location by a GPS network. In Step 542, a GPS chip on the electronic envelope may transmit its present location to the sender computing device, carrier computer, or both. Based on the GPS chip's location, the sender computing device or carrier computer responds with the carrier location nearest to the GPS chip's location. In Step 544, the sender determines whether to deposit the envelope at the carrier location automatically provided by the mobile shipping application. In Step 544, if the sender wishes to deposit an electronic envelope at the carrier location, then the sender may deposit the electronic envelope in Step 550 at the carrier location or may cause the electronic envelope to be deposited at the carrier location. If in Step 544 a sender wishes to deposit an electronic envelope at a different carrier location, then in Step 546, the sender may indicate a desired location address into the mobile shipping application via the sender computing device. In Step 548, the sender computing device, possibly in conjunction with the carrier computer, may return at least one carrier location near a sender desired location. In Step 550, the sender may deposit the electronic envelope, or may cause the electronic envelope to be deposited, at a carrier location indicated by the sender computing device. A sender may also choose to deposit an electronic envelope or may cause an electronic envelope to be deposited at a carrier location other than carrier locations provided by a sender computing device through use of the mobile shipping application. After the electronic envelope is deposited at the carrier location in Step 550, a carrier, in Step 552, may consolidate envelopes at a carrier intake hub.

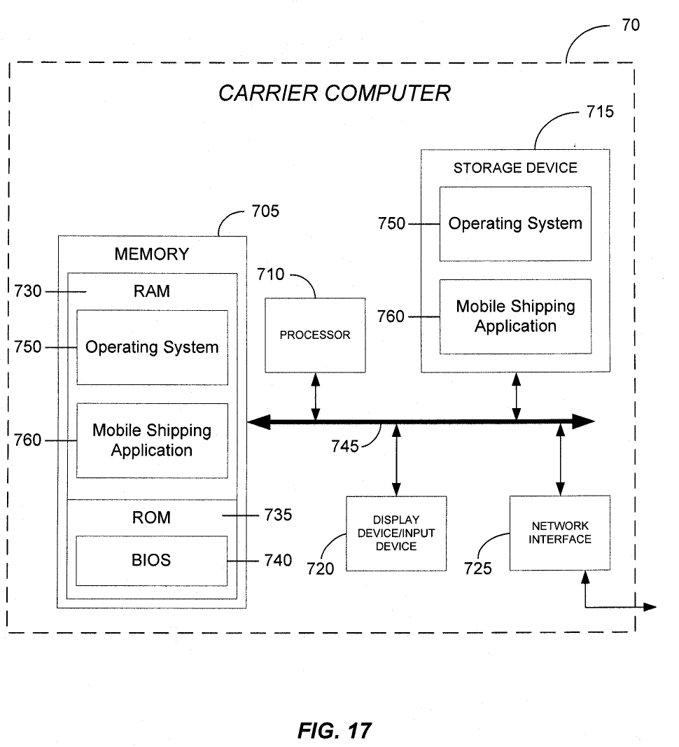

FIG. 17 shows a schematic diagram of a carrier computer 70 according to one embodiment of the invention. As may be understood from this figure, in this embodiment, a carrier computer 70 may include a processor 710 that communicates with other elements within the carrier computer 70 via a system interface or bus 745. Also included in a carrier computer 70 may be a display device/input device 720 for receiving and displaying data. This display device/input device 720 may be, for example, a keyboard or pointing device that is used in combination with a monitor. A carrier computer 70 may further include memory 705, which preferably includes both read only memory (ROM) 735 and random access memory (RAM) 730. A carrier computer's ROM 735 may be used to store a basic input/output system 740 (BIOS), containing the basic routines that help to transfer information across the one or more network 120.

In addition, a carrier computer 70 may include at least one storage device 715, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 715 may be connected to a system bus 745 by an appropriate interface. Storage devices 715 and their associated computer-readable media may provide nonvolatile storage for a personal computer. It is important to note that computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 730. Such program modules may include an operating system 750 and a Mobile Shipping Module 760. A Mobile Shipping Module 760 may control certain aspects of the operation of a carrier computer 70 with the assistance of a processor 710 and an operating system 750.

Also located within a carrier computer 70 may be a network interface 725 for interfacing and communicating with other elements of a computer network. It will be appreciated by one of ordinary skill in the art that one or more of the carrier computer 70 components may be located geographically remotely from other carrier computer 70 components. Furthermore, one or more of the components may be combined, and additional components performing functions described herein may be included in a carrier computer 70.

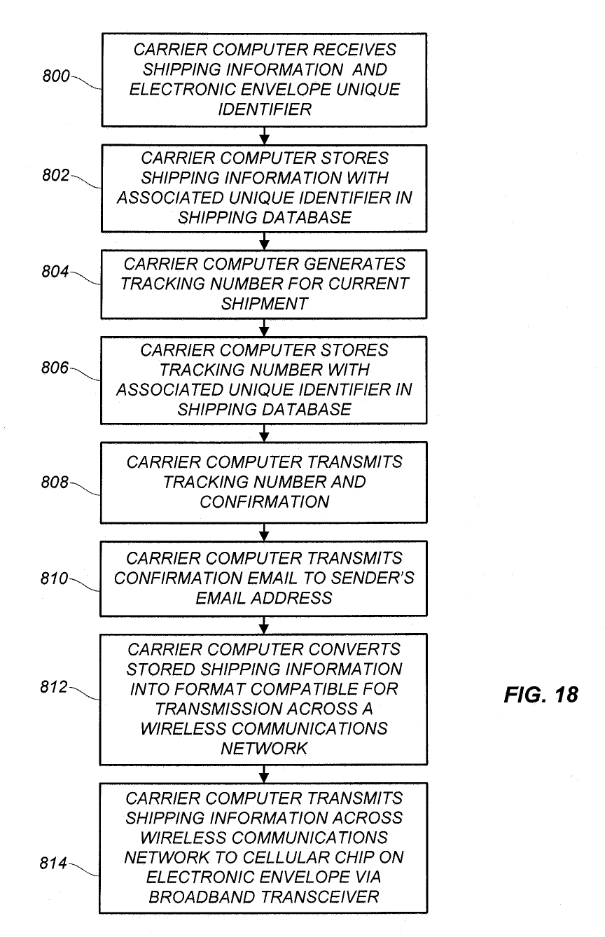

With reference to FIG. 18, a carrier computer may perform the following process. In Step 800, a carrier computer may receive, from a mobile shipping application running on a sender computing device, a sender shipping order along with unique identifier data for an electronic envelope. A shipping order may have already been associated with unique identifier data by a mobile shipping application running on a sender computing device. If not, a carrier computer may associate a shipping order with corresponding unique identifier data. In Step 802, a carrier computer may store shipping order information in a shipping database in association with unique identifier data. In Step 804, a carrier computer may generate a tracking number for a shipping order and, in Step 806, may also store the tracking number in a shipping database along with associated unique identifier data. In Step 808, a carrier computer may transmit a tracking number, a confirmation, or both, to a sender mobile shipping application via a wireless communications network, WAN, LAN, or any communications network. In Step 810, a carrier computer may also transmit a confirmation to a sender email address. In Step 812, the carrier computer may reformat stored shipping information into a format that may be compatible for transmission across a wireless communications network via a broadband transceiver. In Step 814, a carrier computer may transmit shipping information across a wireless communications network to a communications chip on an electronic envelope.

Many modifications and other embodiments of the inventions set forth herein will come to mind to one skilled in the art to which embodiments of these inventions pertain having the benefit of the teachings presented in the foregoing descriptions and the associated drawings. Therefore, it is to be understood that embodiments of the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### CONCLUSION

The described embodiments of the invention are intended to be merely exemplary. Numerous variations and modifications will be apparent to those skilled in the art. All such variations and modifications are intended to fall within the scope of the present disclosure as defined in the appended claims.

What has been described above includes several examples. It is, of course, not possible to describe every conceivable combination of components or methodologies for purposes of describing the systems and applications employed in the shipment of an item using an electronic envelope. However, one of ordinary skill in the art may recognize that further combinations and permutations are possible. Accordingly, the presently disclosed system is intended to embrace alterations, modifications, and variations that fall within the scope of the appended claims. Furthermore, the preceding description is not meant to limit the scope of embodiments of the invention. Rather, the scope of embodiments of the invention is to be determined only by the appended claims and their equivalents.

While the systems and apparatuses herein have been illustrated by describing examples, and while the examples have been described in considerable detail, it is not the intention of the applicants to restrict or in any way limit the scope of the appended claims to such detail. Additional advantages and modifications will be readily apparent to those skilled in the art. Therefore, embodiments of the invention, in broader aspects, are not limited to the specific details, the representative systems and apparatuses, or illustrative examples shown and described. Accordingly, departures may be made from such details without departing from the spirit or scope of the applicant's general inventive concepts. Additionally, all trademarks set forth herein are the property of their respective owners.

That which is claimed:

1. A system for shipping an item comprising:
an electronic envelope including:
an enclosure for shipping an item,
a long-range communications chip fixed to said enclosure, said long-range communications chip configured to receive shipping information related to said electronic envelope,
an updateable electronic display fixed to said enclosure, said updateable electronic display configured to display said shipping information received by said long-range communications chip, and
a microcomputer chip fixed to said enclosure, said microcomputer chip connected to said long-range communications chip and to said updateable electronic display and configured to receive from said long-range communications chip said shipping information provided to said long-range communications chip and to selectively display said shipping information on said updateable electronic display to facilitate handling of said envelope; and
a carrier computer configured to store said shipping information and to communicate with said long-range communications chip on said electronic envelope to provide said long-range communications chip with said shipping information to be displayed on said updateable electronic display.

2. The system from claim 1, wherein said long-range communications chip comprises a cellular chip.

3. The system from claim 1, wherein said microcomputer chip is further configured to display on said updateable electronic display only the shipping information required for handling said electronic envelope at a particular location based on the presence of said electronic envelope at said particular location.

4. The system from claim 1, wherein said microcomputer chip is further configured to receive from said long-range communications chip all shipping information required for shipment of said electronic envelope, store said shipping information, and selectively display said shipping information on said updateable electronic display according to instructions provided by said carrier computer to said long-range communications chip and communicated to said microcomputer chip.

5. The system from claim 1, wherein said microcomputer chip is further configured to receive from said long-range communications chip all shipping information required for shipment of said electronic envelope, store said shipping information, sort said shipping information in chronological order according to the shipping itinerary, and sequentially display said chronologically sorted shipping information on said updateable electronic display according to instructions provided by said carrier computer to said long-range communications chip and communicated to said microcomputer chip.

6. The system from claim 1, wherein said microcomputer chip is further configured to cause said updateable electronic display to display content personalized for the recipient of said electronic envelope in response to delivery of said envelope to said recipient.

7. The system from claim 1, wherein said microcomputer chip is further configured to store said shipping information in an encrypted form and to selectively decrypt said shipping information prior to displaying said shipping information on said updateable electronic display.

8. The system from claim 1, wherein said microcomputer chip is further configured to store personal information of at least a sender or a recipient of said electronic envelope in an encrypted form and to selectively decrypt said personal information prior to displaying said personal information on said updateable electronic display.

9. The system from claim 1, wherein said microcomputer chip is further configured to store destination information related to the electronic envelope in an encrypted form and to selectively decrypt said destination information prior to displaying said destination information on said updateable electronic display.

10. The system from claim 1, wherein said microcomputer chip is further configured to alter destination information that is to be displayed on said updateable electronic display according to instructions provided by said carrier computer to said long-range communications chip if said destination of said electronic envelope is altered after a shipping order has been placed by a sender.

11. The system from claim 1, wherein said microcomputer chip is further configured to alter destination information that is to be displayed on said updateable electronic display according to instructions provided by said carrier computer to said long-range communications chip if said destination of said electronic envelope is altered after said destination information provided in a shipping order has been provided by said carrier computer to said long-range communications chip.

12. The system from claim 1, wherein said carrier computer is further configured to cause said microcomputer chip to selectively display said shipping information on said updateable electronic display according to instructions provided by said carrier computer to said long-range communications chip and communicated to said microcomputer chip.

13. The system from claim 1, wherein said carrier computer is further configured to cause said microcomputer chip to display on said updateable electronic display substantially only the shipping information required for handling said electronic envelope at a particular location based on the presence of said electronic envelope at said particular location.

14. The system from claim 1, wherein said carrier computer is further configured to cause said microcomputer chip to receive from said long-range communications chip all shipping information required for shipment of said electronic envelope, store said shipping information, and selectively display said shipping information on said updateable electronic display according to instructions provided by said carrier computer to said long-range communications chip and communicated to said microcomputer chip.

15. The system from claim 1, wherein said carrier computer is further configured to cause said microcomputer chip to receive from said long-range communications chip all shipping information required for shipment of said electronic envelope, store said shipping information, sort said shipping information in chronological order according to the shipping itinerary, and sequentially display said chronologically sorted shipping information on said updateable electronic display according to instructions provided by said carrier computer to said long-range communications chip and communicated to said microcomputer chip.

16. The system from claim 1, wherein said carrier computer is further configured to sort all shipping information required for shipment of said electronic envelope in chronological order according to the shipping itinerary prior to transmitting shipping information to said long-range communications chip and to cause said microcomputer chip to receive from said long-range communications chip said chronologically sorted shipping information required for shipment of said electronic envelope, store said shipping information, and sequentially display said chronologically sorted shipping information on said updateable electronic display according to instructions provided by said carrier computer to said long-range communications chip and communicated to said microcomputer chip.

17. The system from claim 1, wherein said carrier computer is further configured to cause said microcomputer chip to display on said updateable electronic display content personalized for the recipient of said electronic envelope if said electronic envelope has been delivered to said recipient.

18. The system from claim 1, wherein said carrier computer is further configured to transmit shipping information to said long-range communications chip in periodic intervals, beginning with the placement of a shipping order.

19. The system of claim 1, wherein said carrier computer is further configured to transmit shipping information to said long-range communications chip if said long-range communications chip determines that said electronic envelope is at a carrier location.

20. The system of claim 1, wherein said carrier computer is further configured to transmit shipping information to said long-range communications chip if said long-range communications chip utilizes a global positioning system (GPS) chip included in said long-range communications chip to determine that said electronic envelope is at a carrier location.

21. The system of claim 1, wherein said carrier computer is further configured to transmit shipping information to said long-range communications chip if said long-range communications chip utilizes a global positioning system (GPS) chip included on said enclosure to determine that said electronic envelope is at a carrier location.

22. The system of claim 1, further comprising a transceiver at a carrier location, wherein said transceiver is configured to communicate with said electronic envelope to provide said electronic envelope with the location of said electronic envelope if said electronic envelope is detected by said transceiver so that said updateable electronic display on said electronic envelope can display information based on the location of said electronic envelope.

23. The system from claim 1, wherein said carrier computer is further configured to transmit shipping information to said long-range communications chip if said shipping information is updated in said carrier computer by a sender of said electronic envelope.

24. The system from claim 1, wherein said carrier computer is further configured to transmit shipping information to said long-range communications chip if said shipping information is updated in said carrier computer by a destined recipient of said electronic envelope.
